(19) United States
(12) Patent Application Publication
(10) Pub. No.: US 2026/0154885 A1
(43) Pub. Date: Jun. 4, 2026

(54) Systems, Devices, and Method for Computed Tomography (CT) Reconstruction using Diffusion Posterior Sampling conditioned on a Nonlinear Measurement Model

(71) Applicant: THE JOHNS HOPKINS UNIVERSITY, Baltimore, MD (US)

(72) Inventors: Joseph Webster STAYMAN, Baltimore, MD (US); Xiao JIANG, Baltimore, MD (US); Shudong LI, Baltimore, MD (US); Altea LORENZON, Baltimore, MD (US); Peiqing TENG, Baltimore, MD (US)

(21) Appl. No.: 19/404,394

(22) Filed: Dec. 1, 2025

Related U.S. Application Data
(60) Provisional application No. 63/726,787, filed on Dec. 2, 2024.
(60) Provisional application No. 63/916,816, filed on Nov. 13, 2025.

(51) Int. Cl. G06T 11/00; G06N 3/08

(52) U.S. Cl. CPC G06T 12/20; G06N 3/08; G06T 2211/441

(57) ABSTRACT

A computer system, a non-transitory computer readable medium, and a method for computed tomography (CT) reconstruction. The computer system is configured to perform the method and the computer readable medium is configured to store instructions for performing the method. The method includes obtaining two or more spectral CT measurement data of different materials of a target from one or more 2D or 3D spectral CT images acquired by a CT imaging system using more than one CT imaging energy regimes; and producing a pair reconstructed spectral CT images that are representative of densities of the different materials of the target by performing one or more iterations on the two or more spectral CT measurement data using a trained machine learning network that is trained to performing a diffusion sampling operation and a forward-model-based likelihood on one or more intermediate data sets representing the two or more spectral CT measurement data.

### CROSS REFERENCE TO RELATED APPLICATIONS

This application claims benefit to U.S. Provisional Application No. 63/726,787 filed on Dec. 2, 2024 and U.S. Provisional Application No. 63/916,816 filed on Nov. 13, 2025, the contents of which are hereby incorporated by reference in their entirety.

### GOVERNMENT SUPPORT

This invention was made with government support under grants CA249538 and EB030494 awarded by the National Institutes of Health. The government has certain rights in the invention.

### FIELD OF THE DISCLOSURE

The present disclosure is directed to CT reconstruction, and in particular to systems, devices for CT reconstruction using diffusion posterior sampling conditioned on a nonlinear measurement model.

### BACKGROUND

Neural networks have been widely investigated for CT reconstruction and have shown impressive performance capabilities. Recently, diffusion models have been shown to be particularly powerful deep learning tools for CT reconstruction and restoration. Such methods have generally been based on score-based generative diffusion models through stochastic differential equations (SDEs). Most diffusion models for CT reconstruction have been trained in a supervised manner, where the conditional data input is known in both training and generation These supervised models are subject to reduced performance for application beyond the training data collections. However, some recent strategies demonstrate the ability to extrapolate to new protocols through adaptive learning. Research on image denoising and restoration has demonstrated the potential of unsupervised training by leveraging the power of posterior sampling, where the conditional data input is only available during the reverse-time diffusion process. The unsupervised training does not assume a fixed measurement process during training, and can thus be flexibly incorporated with different measurement models without retraining. In these efforts, measurement model for diffusion posterior sampling has been presumed to be linear. Lopez-Montes et al. have recently applied such an approach using a linearized model to tomographic data. Related work by Xia et al. explores a similar approach with modifications to the update scheme for computational and performance advantages.

Nevertheless, it is well-known that the transmission tomography forward model that relates the underlying attenuation values to the measurements is nonlinear. While the model is commonly linearized for mathematical convenience, such approximation will lose the opportunity to precisely describe those more sophisticated imaging system, thus can result in deviation from the true underlying data model and can cause problems in many circumstances including models for very low dose data, beam-hardening, and detector blur.

There has been a great deal of work seeking to improve image quality in CT reconstruction through deep-learning based denoising; however, there are many applications where it is spatial resolution that limits application and diagnostics. Sophisticated CT measurement models have allowed model-based iterative reconstruction (MBIR) to achieve improved image quality over traditional approaches. Prior efforts have detailed sophisticated models for various physical effects and noise models for CT. There is also much work that focuses on modeling resolution losses in the detection process and incorporating those models into reconstruction of transmission tomography for nuclear imaging and in flat-panel-based computed tomography, where physical effects like light-spread in the scintillator are often a limiting factor for spatial resolution. While previous work in model-based reconstruction has demonstrated an ability to model resolution losses to extend spatial resolution capabilities, MBIR approaches can exhibit unnatural textures.

Recently, diffusion models have been widely applied for denoising and deblurring of CT images, including the score-based generative diffusion models through stochastic differential equations (SDEs). Such models incorporate sophisticated prior knowledge of CT images and have the potential to provide superior noise control without unrealistic blurring or textures. Diffusion modes have been applied to limited-angle, sparse-view, and low-dose CT reconstruction. While many or most of those approaches focus on supervised learning to incorporate prior knowledge, recent research has demonstrated the potential of CT reconstruction using diffusion posterior sampling (DPS) which combines unsupervised training of a generative prior with different measurement models without retraining. Many spectral CT applications require accurate material decomposition. Existing material decomposition algorithms are often susceptible to significant noise magnification or, in the case of one-step model-based approaches, hampered by slow convergence rates and large computational requirements.

Accordingly, the present disclosure addresses one or more the above-noted deficiencies in the current technology of CT image reconstruction.

### SUMMARY

According to examples of the present disclosure, systems, devices, and methods are disclosed that provide one or more software tools for tomographic reconstruction. These tools can include one or more algorithms including, but are not limited to, filtered backprojection, model-based iterative reconstruction, and deep learning approaches. The code base has been developed with many features that permit fast computation and integration with a broad range of parallelizable processing approaches. In particular, the code can include, but is not limited to, fast projection/backprojection code, PyTorch-compliant data structures and functions for GPU-based computation, differentiable functions for integration with neural network training/methods. The codebase can also include deep learning approaches, such as diffusion posterior sampling (DPS) approaches which permit integration of a generative neural network model/image prior with a physical model of the system (e.g. likelihood model of measurements) including, but are not limited to, plug-and-play likelihood updates using different algorithms, a “jumpstart” initialization approach that reduces variability, improves algorithm stability, and reduces computational time, various approaches for 3D data processing (most current research is restricted to 2D methods), functions and code for model-based material decomposition (Spectral CT), and joint estimation of physical effects (e.g. CBCT scatter).

According to examples of the present disclosure, an approach for CT image reduction using diffusion posterior sampling that is conditioned on a nonlinear measurement model (which is referred to as DPS Nonlinear) is disclosed. Specifically, examples of the present disclosure seeks to address the inverse problem of CT image reconstruction via DPS with a score-based diffusion prior and a nonlinear physics-driven measurement likelihood term. This method guides the updates of the reverse-time diffusion process so that the final results are consistent with the raw (nonlinear) measurements from a CT imaging system. According to examples of the present disclosure, one approach trains a traditional score-based diffusion model for unconditional CT image generation and applies Bayes rule by adding the gradient of the log-likelihood, i.e., from the non-linear physical model to achieve the posterior score function necessary for DPS. The method is plug-and-play, meaning it does not require any extra training for application to a different CT system measurement model.

According to examples of the present disclosure, a computer system, a non-transitory computer readable medium, and a method for computed tomography (CT) reconstruction are disclosed. The computer system is configured to perform the method and the non-transitory computer readable medium is configured to store instructions to perform the method. The method comprises obtaining one or more spectral CT measurement data of different materials of a target from one or more 2D or 3D spectral CT images acquired by a CT imaging system using one or more CT imaging energy regimes; and producing a pair reconstructed spectral CT images that are representative of densities of the different materials of the target by performing one or more iterations on the one or more spectral CT measurement data using a trained machine learning network that is trained to performing a diffusion sampling operation and a forward-model-based likelihood on one or more intermediate data sets representing the one or more spectral CT measurement data.

Various additional features can be included in the method including one or more of the following features. The method further comprising performing a filtered backprojection process on the pair of spectral CT measurement data to produce a pair of filtered backprojected spectral data; performing an image-domain decomposition process on the pair of filtered backprojected spectral data to produce a pair of image-domain decomposed spectral data; and adding noise to the pair of image-domain decomposed spectral data to produce a pair of noisy image-domain decomposed spectral data. The forward-model-based likelihood is a model that represents a system physical model. The trained machine learning network applies an estimated probability based on prior conditions to a prior score function estimator with a measurement likelihood score function from the forward-model-based likelihood that is derived from a nonlinear physical model to yield a posterior score function that is used to sample a reverse-time diffusion process. The trained machine learning network applies the estimated probability with a gradient of a log-likelihood from the nonlinear physical model to achieve the posterior score function for diffusion posterior sampling. The trained machine learning network starts at an intermediate state value that is between an initial state value and a final state value to reduce an CT image reconstruction time and a sampling variability, wherein the intermediate state value is approximated using a noisy image estimate, and wherein an initial spectral image comprises an expected level of noise for a starting time step. The likelihood-based forward model comprises a posterior-mean Jacobian term based on a gradient of an attenuation map to be reconstructed and a likelihood gradient term based on a measurement value, a first numeric representation that comprises information representative of system geometry of the CT imaging system, and a second numeric representation that comprises information representative of a pixel-dependent photon fluence, one or more gain factors, and a system induced blur. The method further comprising training a untrained machine learning network by successively adding noise to images acquired by the CT imaging system to yield images representative of pure noise. The untrained machine learning network is trained on multi-material images, wherein the multi-material images comprise bone and water or bone, water, and iodine. The untrained machine learning network is trained on additional information that incorporates system unknowns, wherein the system unknowns comprise spectral sensitivity, gain factors. or physical effects, wherein the physical effects comprise scattered radiation. The trained machine learning network is configured to process images produced by CT imaging systems with different system geometries and different operating parameters than the CT imaging system that is used to train the trained machine learning network. One or more discontinuities between adjacent slices of the spectral data are corrected by a total variation regularization process along a vertical or z-direction.

According to examples of the present disclosure, a computer system is disclosed that comprises a processor; and a computer-readable medium storing instructions to perform a method for computed tomography (CT) reconstruction, the method comprising: obtaining two or more spectral CT measurement data of different materials of a target from one or more 2D or 3D spectral CT images acquired by a CT imaging system using more than one CT imaging energy regimes; and producing a pair reconstructed spectral CT images that are representative of densities of the different materials of the target by performing one or more iterations on the two or more spectral CT measurement data using a trained machine learning network that is trained to performing a diffusion sampling operation and a forward-model-likelihood on one or more intermediate data sets representing the two or more spectral CT measurement data.

Various additional features can be included in the method including one or more of the following features. The method further comprises performing a filtered backprojection process on the pair of spectral CT measurement data to produce a pair of filtered backprojected spectral data; performing an image-domain decomposition process on the pair of filtered backprojected spectral data to produce a pair of image-domain decomposed spectral data; and adding noise to the pair of image-domain decomposed spectral data to produce a pair of noisy image-domain decomposed spectral data. The forward-model-based likelihood is a model that represents a system physical model. The trained machine learning network applies an estimated probability based on prior conditions to a prior score function estimator with a measurement likelihood score function from the forward-model-based likelihood that is derived from a nonlinear physical model to yield a posterior score function that is used to sample a reverse-time diffusion process. The trained machine learning network applies the estimated probability with a gradient of a log-likelihood from the nonlinear physical model to achieve the posterior score function for diffusion posterior sampling. The trained machine learning network starts at an intermediate state value that is between an initial state value and a final state value to reduce an CT image reconstruction time and a sampling variability, wherein the intermediate state value is approximated using a noisy image estimate, and wherein an initial spectral image comprises an expected level of noise for a starting time step. The likelihood-based forward model comprises a posterior-mean Jacobian term based on a gradient of an attenuation map to be reconstructed and a likelihood gradient term based on a measurement value, a first numeric representation that comprises information representative of system geometry of the CT imaging system, and a second numeric representation that comprises information representative of a pixel-dependent photon fluence, one or more gain factors, and a system induced blur.

According to examples of the present disclosure, a non-transitory computer readable medium that stores instructions, that when executed by a processor, performs a method for computed tomography (CT) reconstruction is disclosed. The method comprises obtaining a pair spectral CT measurement data of different materials of a target from one or more 2D or 3D spectral CT images acquired by a CT imaging system using more than one CT imaging energy regimes; performing a filtered backprojection process on the pair of spectral CT measurement data to produce a pair of filtered backprojected spectral data; performing an image-domain decomposition process on the pair of filtered backprojected spectral data to produce a pair of image-domain decomposed spectral data; adding noise to the pair of image-domain decomposed spectral data to produce a pair of noisy image-domain decomposed spectral data; and producing a pair reconstructed spectral CT images that are representative of densities of the different materials of the target by performing one or more iterations on the pair of noisy image-domain decomposed spectral data using a trained machine learning network that is trained to performing a diffusion sampling operation and a forward-model-based likelihood on one or more intermediate data sets representing the pair of noisy image-domain decomposed spectral data. The method can further comprise performing a filtered backprojection process on the pair of spectral CT measurement data to produce a pair of filtered backprojected spectral data; performing an image-domain decomposition process on the pair of filtered backprojected spectral data to produce a pair of image-domain decomposed spectral data; and adding noise to the pair of image-domain decomposed spectral data to produce a pair of noisy image-domain decomposed spectral data.

According to examples of the present disclosure, a method for computed tomography (CT) reconstruction is disclosed. The method comprises obtaining a single set of projection data of a target from one or more 2D or 3D CT images acquired by a CT imaging system using a single CT imaging energy regime; and producing a signal volume of attenuation coefficients that are representative of the target by performing one or more iterations on the two or more CT measurement data using a trained machine learning network that is trained to performing a diffusion sampling operation and a forward-model-based likelihood on one or more intermediate data sets representing the two or more CT measurement data. The trained machine learning network applies an estimated probability based on prior conditions to a prior score function estimator with a measurement likelihood score function from the forward-model-based likelihood that is derived from a nonlinear physical model to yield a posterior score function that is used to sample a reverse-time diffusion process. The trained machine learning network applies the estimated probability with a gradient of a log-likelihood from the nonlinear physical model to achieve the posterior score function for diffusion posterior sampling. The trained machine learning network starts at an intermediate state value that is between an initial state value and a final state value to reduce an CT image reconstruction time and a sampling variability, wherein the intermediate state value is approximated using a noisy image estimate, and wherein an initial spectral image comprises an expected level of noise for a starting time step. The likelihood-based forward model comprises a posterior-mean Jacobian term based on a gradient of an attenuation map to be reconstructed and a likelihood gradient term based on a measurement value, a first numeric representation that comprises information representative of system geometry of the CT imaging system, and a second numeric representation that comprises information representative of a pixel-dependent photon fluence, one or more gain factors, and a system induced blur.

### BRIEF DESCRIPTION OF THE FIGURES

FIG. 1 shows a method of spectral diffusion posterior sampling according to examples of the present disclosure.

FIG. 2A shows a summary of the processing used to create the two-material dataset from public single-energy CT images according to examples of the present disclosure.

FIG. 2B shows example images in the synthetic two-material dataset according to examples of the present disclosure.

FIG. 3 shows normalized spectral sensitivities of the CT systems used in the simulation studies as well as the estimated sensitivities for the physical data experiments according to examples of the present disclosure.

FIG. 4 shows STD maps for different combinations of hyperparameters according to examples of the present disclosure.

FIG. 5 shows performance of parameter sets optimized at 0.1mAs/view on different dose levels according to examples of the present disclosure.

FIG. 6 shows normalized STD (right) for 4 slices (left) at different locations according to examples of the present disclosure.

FIG. 7 shows sample Spectral DPS results and the corresponding STD maps with different parameter settings according to examples of the present disclosure.

FIG. 8 shows the relationship between STD and other metrics, i.e., bias, PSNR, and SSIM computed on the same slice as that used in FIG. 4.

FIG. 9 shows material decompositions for simulated dual-layer CT system according to examples of the present disclosure.

FIG. 10 shows material decompositions for simulated kV-switching CT system according to examples of the present disclosure.

FIG. 11 shows multiple samplings of ROIs in FIG. 9 and FIG. 10 using diffusion-based algorithms according to examples of the present disclosure, where pixel-wise STD maps are shown in the right column.

FIG. 12 shows likelihood loss (11) curves of the last 200 steps of the Baseline and Spectral DPS according to examples of the present disclosure.

FIG. 13 show diffusion-based decomposition results under different tube voltages according to examples of the present disclosure, where the left part illustrates the selected ROIs, middle part displays the error maps of different decomposition algorithms, and the right part shows how the quantitative metrics change with the varied tube voltages.

FIG. 14 shows ablation study results according to examples of the present disclosure.

FIG. 15 shows material decomposition on the bench CBCT system according to examples of the present disclosure.

FIG. 16 shows a STD map of diffusion-based algorithms evaluated on 32 posterior samplings from bench data, where the top and bottom row represents water and bone STD, respectively, according to examples of the present disclosure.

FIG. 17 shows percentage error of noiseless projections simulated with optimized § and q of different compressed energy bins according to examples of the present disclosure.

FIG. 18 shows sinogram and FBP images generated from noiseless projection simulated via discretized model (150 bins) and compress model (8 bins) according to examples of the present disclosure.

FIG. 19 shows the RMSE of the entire reconstructed volume as a function TV regularization strength (β_{TV}) according to examples of the present disclosure.

FIG. 20 compares the results of different algorithms. IDD exhibits significant noise and bias due to the ill-conditioned and linearized model, while InceptNet effectively reduces noise and improves accuracy, according to examples of the present disclosure.

FIG. 21 shows cardiac ROI in calcium images according to examples of the present disclosure.

FIG. 22 illustrates an example of such a computing system 2200, in accordance with some examples.

### DETAILED DESCRIPTION

Reference will now be made in detail to example implementations, illustrated in the accompanying drawings. Wherever possible, the same reference numbers will be used throughout the drawings to refer to the same or like parts. In the following description, reference is made to the accompanying drawings that form a part thereof, and in which is shown by way of illustration specific exemplary embodiments in which the invention may be practiced. These embodiments are described in sufficient detail to enable those skilled in the art to practice the invention and it is to be understood that other embodiments may be utilized and that changes may be made without departing from the scope of the invention. The following description is, therefore, merely exemplary.

Accurate material decomposition is critical for many spectral CT applications. In this disclosure, a framework-spectral diffusion posterior sampling (Spectral DPS)-designed for one-step reconstruction and multi-material decomposition is disclosed. Methods: Spectral DPS combines sophisticated prior information captured by one-time unconditional network training and an arbitrary analytic physical system model. Built upon the general DPS framework for nonlinear inverse problems, Spectral DPS incorporates several DPS strategies from our previous work, including jumpstart sampling, Jacobian approximation, and multi-step likelihood updates. The effectiveness of Spectral DPS was evaluated on a simulated dual-layer and a kV-switching spectral system as well as on a physical cone-beam CT (CBCT) test bench. In comparison with other diffusion-based algorithms, Spectral DPS showed significant improvements in reducing sampling variability and computational costs over Baseline DPS. Additionally, Spectral DPS outperformed Conditional Denoising Diffusion Probabilistic Model (DDPM), which was trained on specific imaging conditions, in terms of imaging accuracy and robustness across different imaging protocols. In the physical phantom study, Spectral DPS achieved a<1% error in estimating the mean density in a homogeneous region, while effectively avoiding the introduction of false structures seen in Baseline DPS. Both simulation and physical phantom studies demonstrated the superior performance of Spectral DPS on accurate, stable, and fast material decomposition. The disclosed Spectral DPS provided a novel and general material decomposition framework which can effectively combine learning-based prior and physics-based spectral model. This method can be applied to various spectral CT systems and basis materials.

### Methodology

### Physics Model of Spectral CT System

TABLE I
Spectral CT System Parameters and Notation

| Parameter | Notation | Size |
|---|---|---|
| Number of spectral channels | J | |
| Number of basis materials | K | |
| Number of image voxels | M | |
| Number of measurements in the j th channel | Pⱼ | |
| Number of energy bins | R | |
| The k th basis material image | xₖ | M × 1 |
| The k th basis material mass attenuation | Qₖ | R × 1 |
| The j th channel system matrix | Aⱼ | Pⱼ × M |
| The j th channel spectrum | Sⱼ | R × 1 |
| The j th channel blur | Bⱼ | Pⱼ × Pⱼ |
| The j th channel measurements | yⱼ | Pⱼ × 1 |
| The j th channel measurement covariance | Kⱼ | Pⱼ × Pⱼ |
| Identity matrix | I^{J} | J × J |

Various spectral CT system designs with significant differences in system geometry, detector physics, and spectral sensitivity have been investigated in both the literature and clinical applications. This disclosure uses a general spectral CT model. For each energy channel, the discretized mean measurement model is:

$${y}_{i} = {\sum }_{{i}^{′} ∈} {b}_{i {i}^{′}} {\sum }_{r = 1}^{R} {s}_{{i}^{′} r} Δ E exp \{ - {\sum }_{k = 1}^{K} {q}_{kr} {\sum }_{m} {a}_{{i}^{′} m} {x}_{mk} \} \qquad ( 1 )$$

where i, r, k, m is the index of detector pixel, energy bin, basis material, and voxel, respectively. The b and s terms characterize channel-specific blur kernel and spectral sensitivity. The xₘₖ term represents the basis-material density while a_{i′m} and qₖ denote the corresponding path length and mass attenuation coefficients. With the assumption of multivariate Gaussian noise, the noisy measurement model can be written in the following compact form:

$$y ∼ ( \overline{y} , K ) , \overline{y} = BS exp ( - QAx ) , \qquad ( 2 )$$

where

$$y = [ \begin{matrix}{y}_{1} \\ ⋮ \\ {y}_{J}\end{matrix} ] , x = [ \begin{matrix}{x}_{1} \\ ⋮ \\ {x}_{K}\end{matrix} ] , K = [ \begin{matrix}{K}_{1} & & \\ & ⋱ & \\ & & {K}_{J}\end{matrix} ]$$

$$B = [ \begin{matrix}{B}_{1} & & \\ & ⋱ & \\ & & {B}_{J}\end{matrix} ] , S = [ \begin{matrix}{S}_{1}^{T} ⊗ {I}^{{P}_{1}} & & \\ & ⋱ & \\ & & {S}_{J}^{T} ⊗ {I}^{{P}_{J}}\end{matrix} ]$$

$$Q = [ {I}^{J} ⊗ {Q}_{1} ⊗ {I}^{{P}_{1}} , … , {I}^{J} ⊗ {Q}_{K} ⊗ {I}^{{P}_{J}} ] ,$$

$$A = {I}^{K} ⊗ [ \begin{matrix}{A}_{1} \\ ⋮ \\ {A}_{J}\end{matrix} ]$$

The notation definition is summarized in Table I. Terms Aⱼ, Sⱼ, Bⱼ defines the system geometry, spectrum, and blur effects, respectively. Matrix K characterizes the measurements noise covariance. Presuming the measurement noise is uncorrelated, with variance proportional to the measurements, the covariance matrix can be well approximated as K≈Diag{y}. One could alternately adopt a Poisson noise model, which is accurate for low-count data without detector readout noise. Based on recent studies, a Gaussian approximation is used which also permits more straightforward modeling of noise correlation.

The forward model (1) accommodates any number of basis materials and spectral channels. Additionally, it accounts for arbitrary channel-wise spectra, system geometries, and blur models, permitting accurate representations of a wide range of spectral systems including photon-counting, dual-layer, and kV-switching CT as well as more exotic spectral CT systems that use unusual/sparse sampling approaches. Material decomposition aims to reconstruct the basis material density x from the spectral measurements y. Model-based algorithms perform the material decomposition by maximizing the posterior probability:

$$\begin{matrix}\hat{x} & = argmaxlog p ( x \vert y ) \\ & = argmaxlog p ( y \vert x ) + log p ( x ) \\ & = argmax - {\underbrace{{‖ BSexp ( - QAx ) - y ‖}_{{K}^{- 1}}^{2}}}_{Likelihood} + {\underbrace{log p ( x )}}_{Prior}\end{matrix} \qquad ( 3 )$$

The physical model of the spectral system determines the likelihood term, while the prior information of x is encoded in the second term. Mathematically, (3) is a nonlinear problem without an explicit solution. Therefore, solutions are typically estimated through iterative optimization algorithms.

### Spectral Diffusion Posterior Sampling

Denoising Diffusion Probabilistic Model: Conventional model-based algorithms commonly apply simple analytic forms for the prior distribution, which typically do not capture the complexity of the actual image distribution. Score-based generative models (SGM) have been widely explored to accurately represent high-dimensional data distributions, which provides a strategy to learn the data distribution by estimating the gradient of the prior probability density ∇ₓ log pₜ (x). Denoising Diffusion Probabilistic Model (DDPM) have became one of the most popular SGMs. Specifically, given a target-domain dataset, DDPM gradually degrades each sample with time-dependent Gaussian noise described by a forward stochastic differential equation (SDE):

$$dx = - \frac{{β}_{t}}{2} xdt + \sqrt{{β}_{t}} dw \qquad ( 4 )$$

where βₜ defines the time-dependent noise variance and dw represents the standard Wiener process. This forward process may be inverted through a reverse SDE:

$$dx = \{ - \frac{{β}_{t}}{2} x - {β}_{t} {∇}_{{x}_{t}} log {p}_{t} ( {x}_{t} ) \} dt + \sqrt{{β}_{t}} d \overline{w} \qquad ( 5 )$$

where dw̅ denotes the Wiener process with reverse time flow. The forward process (4) gradually corrupts the sample from target distribution to pure noise. Conversely, the reverse process (5) generates samples of the prior distribution starting from pure noise. The unknown probability gradient ∇ₓ_{ₜ} log pₜ (xₜ), referred to as the score function, may be approximated by a neural network s_{θ}(xₜ, t)≈∇ₓ_{ₜ} log pₜ (xₜ), which is trained on the target-domain dataset. In practice, (4) and (5) are discretized into T time steps, and a denoising network is trained to estimate the scaled score function: ∈_{θ}(xₜ, t)≈−\sqrt{1−α̅ₜ}∇ₓ_{ₜ} log pₜ (xₜ) where

$${\overline{α}}_{t} = {\prod }_{i = 1}^{t} ( 1 - {β}_{i} ) .$$

### Algorithm 1: Unconditional DDPM Training.

Algorithm 1: Unconditional DDPM Training.

```
  1: T: diffusion training time steps
  2: ϵ_{θ}: score network
  3: while not converged do:
  4: x₀ ~ p(x₀)
  5: t ~ U(1, 2, ... , T)
  6: ϵ ~ [symbol] (0, I^{M} ⊗ I^{K})
  $7 : {x}_{t} = \sqrt{{\overline{α}}_{t}} {x}_{0} + \sqrt{1 - {\overline{α}}_{t}} ϵ$
  8: Update θ with gradient:
  $9 : {∇}_{θ} {‖ ϵ - {ϵ}_{θ} ( {x}_{t} , t ) ‖}_{2}^{2}$
10: end while
```

Diffusion Posterior Sampling: Based on the same principles of unconditional generation, the posterior probability p(x|y) can be sampled by running a reverse process:

$$dx = \{ - \frac{{β}_{t}}{2} x - {β}_{t} {∇}_{{x}_{t}} log {p}_{t} ( {x}_{t} \vert y ) \} dt + \sqrt{{β}_{t}} d \overline{w} \qquad ( 6 )$$

Equation (6) necessitates the training of a conditional score network s_{θ}(xₜ, y,t)≈∇ₓ_{ₜ} log pₜ (xₜ|y) on paired (x, y). Leveraging Bayes' rule, Diffusion posterior sampling (DPS) rewrites the reverse process as:

$$dx = {\underbrace{\{ - \frac{{β}_{t}}{2} x - {β}_{t} {∇}_{{x}_{t}} log {p}_{t} ( {x}_{t} ) \} d t + \sqrt{{β}_{t}} d \overline{w}}}_{Unconditional reverse sampling , Eq . ( 5 )} - {\underbrace{{β}_{t} {∇}_{{x}_{t}} log {p}_{t} ( y \vert {x}_{t} ) dt}}_{Likelihood gradient} . \qquad ( 7 )$$

Equation (7) illustrates that the posterior reverse sampling may be split into unconditional reverse sampling and gradient descent on the data likelihood. The intractable likelihood on xₜ is further approximated using Tweedie's formula:

$${p}_{t} ( y \vert {x}_{t} ) \approx {p}_{t} ( y \vert {\hat{x}}_{0} ) , where {\hat{x}}_{0} = \frac{1}{\sqrt{{\overline{α}}_{t}}} ( {x}_{t} + ( 1 - {\overline{α}}_{t} ) {s}_{θ} ( {x}_{t} , t ) ) \qquad ( 8 )$$

In the context of medical imaging reconstruction, the data likelihood is formed based on a physical model of the measurements y, and in (7), the data likelihood is separated from the unconditional reverse sampling, which allows one to train a purely generative model on the target-domain dataset then apply it to posterior sampling on arbitrary imaging systems. This sampling strategy provides a flexible framework to incorporate an accurate physics model and sophisticated prior information into the image reconstruction.

Material Decomposition Using Spectral DPS: Combining the spectral CT physics model and diffusion posterior sampling, the DPS for multi-material reconstruction and decomposition can be represented as:

$$d x = \{ - \frac{{β}_{t}}{2} x - {β}_{t} {∇}_{{x}_{t}} log {p}_{t} ( {x}_{t} ) \} d t + \sqrt{{β}_{t}} d \overline{w} + {β}_{t} {∇}_{{x}_{t}} {\hat{x}}_{0} ( {x}_{t} ) {∇}_{{\hat{x}}_{0}} {‖ BS exp ( - A {\hat{x}}_{0} ( {x}_{t} ) ) - y ‖}_{{K}^{- 1}}^{2} dt \qquad ( 9 )$$

### Algorithm 2: Baseline DPS Sampling

Algorithm 2: Baseline DPS Sampling.

```
  1: T: diffusion training time steps
  2: ϵ_{θ}: score network
  3: ηₜ: step size of the likelihood update
  4:
  5: x_{T} ~ [symbol] (0, I^{M} ⊗ I^{K})
  6: for t = T to 1 do:
  7: z ~ [symbol] (0, I^{M} ⊗ I^{K})
  $8 : {\hat{x}}_{0} = \frac{1}{\sqrt{{\overline{α}}_{t}}} ( {x}_{t} - \sqrt{1 - {\overline{α}}_{t}} {ϵ}_{θ} ( {x}_{t} , t ) )$
  $9 : {x}_{t - 1}^{′} = \frac{\sqrt{\text{?}} ( 1 - {\overline{α}}_{t - 1} )}{1 - {\overline{α}}_{t}} {x}_{t} + \frac{\sqrt{\text{?}} {β}_{t}}{1 - {\overline{α}}_{t}} {\hat{x}}_{0} + {σ}_{t} z$
$10 : {x}_{t - 1} = {x}_{t - 1}^{′} - {η}_{t} {∇}_{{x}_{t}} {\hat{x}}_{0} ( {x}_{t} ) {∇}_{{\hat{x}}_{0}} {‖ BS exp ( - A {\hat{x}}_{0} ( {x}_{t} ) ) - y ‖}_{{K}^{- 1}}^{2}$
11: end for
```

$\text{?} \text{indicates text missing or illegible when filed}$

The detailed implementation of (9) is summarized in Algorithm 2, which is referred as Baseline DPS. The original step size βₜ is replaced by a hand-crafted scheduler ηₜ to enable more flexible step size management. The training of score network ∈_{θ}, which is used to approximate ∇ₓ_{ₜ} log pₜ (xₜ), is summarized in Algorithm 1 and detailed in below. While Baseline DPS has demonstrated the ability to produce realistic images, such an approach can suffer low sampling efficiency, large sampling variability, and poor data consistency, particularly for ill-conditioned nonlinear problems such as onestep material decomposition.

Reduced sampling steps: A jumpstart strategy is applied wherein many reverse time steps are skipped. For many medical imaging reconstruction problems, a direct first-pass reconstruction \hat{x}₀ can be efficiently computed. Though the first-pass results may be corrupted by noise and various artifacts, this discrepancy with ground truth x₀ is mitigated through the forward diffusion since the random noise gradually dominates the images. For sufficiently large t=T′, x_{T′} and \hat{x}_{T′} conform to almost the same distribution. This permits starting reverse sampling from \hat{x}_{T′} rather than the pure noise. In this work, filtered backprojection followed by image-domain decomposition (detailed in below), is used to approximate \hat{x}₀, and the optimal T′, which controls the amount of noise added to \hat{x}₀, is determined by a parameter sweep.

Simplified Jacobian computation: The computation of the posterior mean Jacobian ∇ₓ_{ₜ} \hat{x}₀ (xₜ) is both memory and time intensive because of the gradient backpropagation through the deep network. Here, an approach is adapted that computes the likelihood gradient with respect to the posterior mean \hat{x}₀ instead of individual posterior sample to reduce computational burden as well as stabilize the gradient computation. Then the reverse sampling is rewritten as:

$$d x = \{ - \frac{{β}_{t}}{2} x - {β}_{t} {∇}_{{x}_{t}} log {p}_{t} ( {x}_{t} ) \} d t + \sqrt{{β}_{t}} d \overline{w} + {β}_{t} {∇}_{{\hat{x}}_{0}} {‖ BS exp ( - A {\hat{x}}_{0} ) - y ‖}_{{K}^{- 1}}^{2} dt \qquad ( 10 )$$

Efficient multi-step optimization: The likelihood update in (10) can be viewed as the following likelihood minimization problem on posterior mean solved by single-step gradient descent:

$$arg {min}_{{\hat{x}}_{0}} {‖ BS exp ( - A {\hat{x}}_{0} ) - y ‖}_{{K}^{- 1}}^{2} , \qquad ( 11 )$$

which is not necessarily able to achieve sufficient data consistency especially for a nonlinear ill-posed problem. The multi-step gradient descent, the ordered-subsets strategy, and the Adaptive Moment Estimation (Adam) optimizer are combined to address this issue without significantly compromising computational efficiency. Specifically, gradient descent iterations are executed multiple times to update \hat{x}₀ in each time step. The resulting increased computational cost can be compensated by the ordered subsets strategy. This technique is built on the principle that the likelihood gradient can be well approximated by the gradient computed on a subset of all projection data:

$${∇}_{{x}_{0}} ℒ ( {x}_{0} , y ) \approx S {∇}_{{x}_{0}} ℒ ( {x}_{0} , {y}_{s} ) , \qquad ( 12 )$$

where S and s is the number of subsets and the subset index, respectively. In this disclosure, the likelihood update applies all subset updates in each time step. As such, the number of subsets is the same as the number of gradient descent updates per time step. An Adam optimizer is used to further improve the convergence rate with a smooth optimization trajectory and adaptive step size.

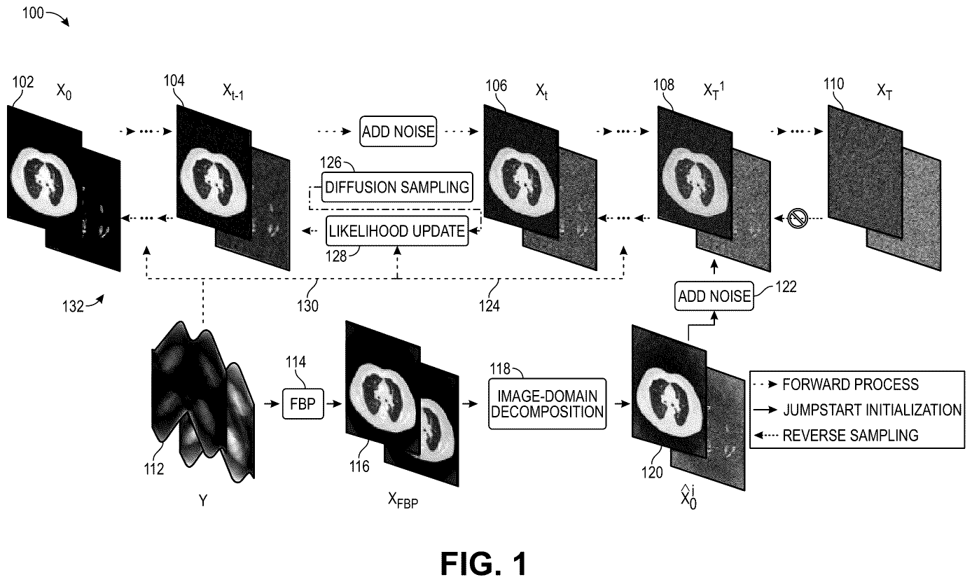

DPS equipped with these improved strategies is referred to as Spectral DPS. Implementation of Spectral DPS is summarized in FIG. 1 with pseudocode in Algorithm 3.

Parameter Selection: Spectral DPS has three hyperparameters—the number of jumpstart time steps T′, the number of subsets S, and the step size η, which is critical to the sampling performance. One of the distinct features of DPS, as compared to conventional algorithms, is that the results exhibit variability, i.e., sampling results vary even when conditioned on the same measurement realization due to the inherently stochastic processing. This variability is quantified by computing the standard deviation (STD) over 32 posterior samplings:

$$STD = \frac{1}{M} ‖ \sqrt{\{ {( \{ \hat{x} \} - \hat{x} )}^{2}} \} {‖}_{1} . \qquad ( 13 )$$

This variability may be unfavorable in medical imaging applications. To address this issue, the three hyperparameters T′, S, and n, are swept and the combination which minimizes the STD are chosen. Additionally, the impact of STD minimization on other image quality metrics and how optimal parameters change with anatomical locations are investigated, which gives insight into whether the optimal parameters can improve the overall image quality and can be applied universally.

### Unconditional Diffusion Model Training

FIG. 1 shows a method 100 of spectral diffusion posterior sampling according to examples of the present disclosure. In the forward process a set of material basis images is simultaneously and incrementally degraded by noise. A reverse process is defined that restores those images conditioned on the measurement data. The jumpstart procedure is also illustrated permitting one to skip a number of initial reverse time steps for computation reduction and improved stability.

As shown in FIG. 1, a training portion of the method 100 is shown going from left to right in the top row and begins by generating a dataset 102 comprising a plurality of pairs of spectral CT images acquired using at least two different spectral energies and depicting two different materials (water and calcium (or bone)), denoted by x₀. The plurality of pairs of Ct images are successively degraded by adding noise at successive timestep intervals xₜ₋₁ 104, xt 106, x_{T′} 108, until a final pairs of pure noise images are produced at x_{T} 110.

Also shown in FIG. 1, an inference portion of the method 100 is shown going from left to right in the bottom row and then right to left in the top row. The inference portion of the method 100 begins by obtaining a pair of spectral CT measurements (also called spectral projections that are the raw data acquired by a spectral CT scanner that details how the X-ray beam is attenuated across multiple specific energy levels) acquired using two different spectral energies depicting two different materials (water and calcium (or bone)), denoted by y at 112. The pair of spectral CT measurements are then processed using a filtered back projection (FBP) algorithm at 114 producing a pair of FBT images, XFBP. The pair of FBT images are then processed using an image-domain decomposition algorithm at 118 producing a pair of image-domain decomposed images,

$${\hat{x}}_{0}^{i}$$

at 120. Noise is added to the pair of image-decomposed images at 122 producing a pair of images denoted by x_{T′} 122. The pairs of images x_{T′} are initially denoised to produce an initial pair of denoised images xₜ at 124. The pair of initial denoised images xₜ are then processed using a diffusion sampling algorithm 126 and a likelihood update algorithm 128 that is trained, as discussed above and further below, to produce a pair of more denoised images xₜ₋₁ at 130, and then a final pair of images X₀ at 132 that yield an image representing the calcium density and an image of the water density in each voxel in the target area of the subject of the spectral CT image that was produced using the CT apparatus.

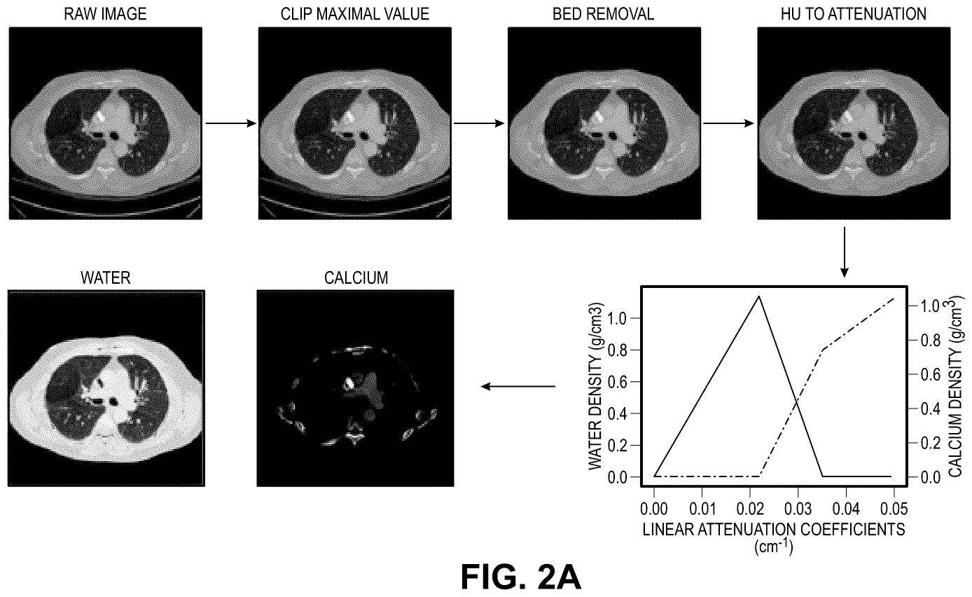

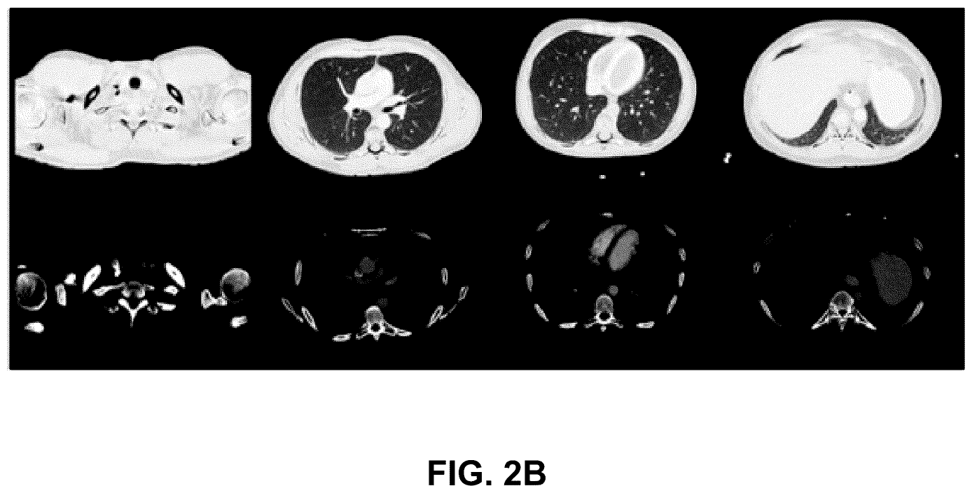

Dataset Generation: The dataset generation procedure is summarized in FIG. 2A. Water/calcium decomposition is studied below. A two-material dataset was created based on the public CT Lymph Nodes dataset, from which chest-region slices were extracted from 150 distinct patients, forming a CT dataset of 30000 slices. Pre-processing includes bed removal via morphological operations and metal reduction via clipping the maximum value to 2000 HU. Hounsfield unit values were converted into attenuation coefficients, and then water and calcium densities (unit: g/cm³) were determined by two soft-threshold functions:

$${x}_{w} ( μ ) = \{ \begin{matrix}{k}_{w} μ , & if μ \leq {μ}_{w} \\ {k}_{w} {μ}_{w} - {k}_{wc} ( μ - {μ}_{w} ) , & if {μ}_{w} < μ < {μ}_{c} \\ 0 , & otherwise\end{matrix} \qquad ( 14 a )$$

$${x}_{c} ( μ ) = \{ \begin{matrix}{k}_{c} ( μ - {μ}_{c} ) + {k}_{cw} ( {μ}_{c} - {μ}_{w} ) , & if μ \leq {μ}_{c} \\ {k}_{cw} ( μ - {μ}_{w} ) , & if {μ}_{w} < μ < {μ}_{c} \\ 0 , & otherwise\end{matrix} \qquad ( 14 b )$$

The parameters, k_{w}, k_{wc}, k_{cw}, k_{c} were empirically set to 5.18, −8.77,5.69,2.12 g/cm², while μ_{w} and μ_{c} were 0.22 cm⁻¹ and 0.35 cm⁻¹. FIG. 2B illustrates example images in the synthetic two-material dataset. Part of the soft tissue, notably in the heart region, exhibits high intensity in the calcium images because of iodine contrast enhancement.

### Algorithm 3: Spectral DPS Sampling

Algorithm 3: Spectral DPS Sampling.

```
  1: T: diffusion training time steps
  2: T′: jumpstart steps, T′ << T
  3: ϵ_{θ}: score network
  $4 : {\hat{x}}_{0}^{i} : image - domain decomposition$
  6: # Adam optimizer
  7: η: step size
  8: γ₁ = 0.9, γ₂ = 0.999: momentum coefficients
10: # Order subset
11: S: number of subset
12: {Aₛ, yₛ}: subset forward projector and spectral
      measurements
14: # Reverse sampling initialization
15: ϵ ~ [symbol] (0, I^{M} ⊗ I^{K})
$16 : {x}_{{T}^{′}} = {\hat{x}}_{{T}^{′}}^{i} = \sqrt{{\overline{α}}_{{T}^{′}}} {\hat{x}}_{0}^{i} + \sqrt{1 - {\overline{α}}_{{T}^{′}}} ϵ$
18: # Posterior sampling
19: for t =T′ to 1 do:
20: # Diffusion sampling:
21: z ~ [symbol] (0, I^{M} ⊗ I^{K})
$22 : {\hat{x}}_{0} = \frac{1}{\sqrt{{\overline{α}}_{t}}} ( {x}_{t} - \sqrt{1 - {\overline{α}}_{t}} {ϵ}_{θ} ( {x}_{t} , t ) )$
$23 : {x}_{t - 1}^{′} = \frac{\sqrt{\text{?}} ( 1 - {\overline{α}}_{t - 1} )}{1 - {\overline{α}}_{t}} {x}_{t} + \frac{\sqrt{{\overline{α}}_{t - 1}} {β}_{t}}{1 - {\overline{α}}_{t}} {\hat{x}}_{0} + {σ}_{t} z$
25: # Likelihood update:
$26 : {\hat{x}}_{0}^{′} = {\hat{x}}_{0}$
27: for s = 1 to S do:
$28 : {\hat{x}}_{0}^{′} = Adam ( {\hat{x}}_{0}^{′} , S {∇}_{{\hat{x}}_{0}^{′}} {‖ BS exp ( - {QA}_{s} {\hat{x}}_{0}^{′} ) - {y}_{s} ‖}_{{K}^{- 1}}^{2} )$
29: end for
$30 : {x}_{t - 1} = {x}_{t - 1}^{′} - {\hat{x}}_{0} + {\hat{x}}_{0}^{′}$
31: end for
```

$\text{?} \text{indicates text missing or illegible when filed}$

FIG. 2A shows a summary of the processing used to create the two-material dataset from public single-energy CT images according to examples of the present disclosure. FIG. 2B shows example images in the synthetic two-material dataset according to examples of the present disclosure. Top and bottom rows are paired water and calcium images. Display window: water: [0,1.2] g/ml, calcium: [0,0.2] g/ml.

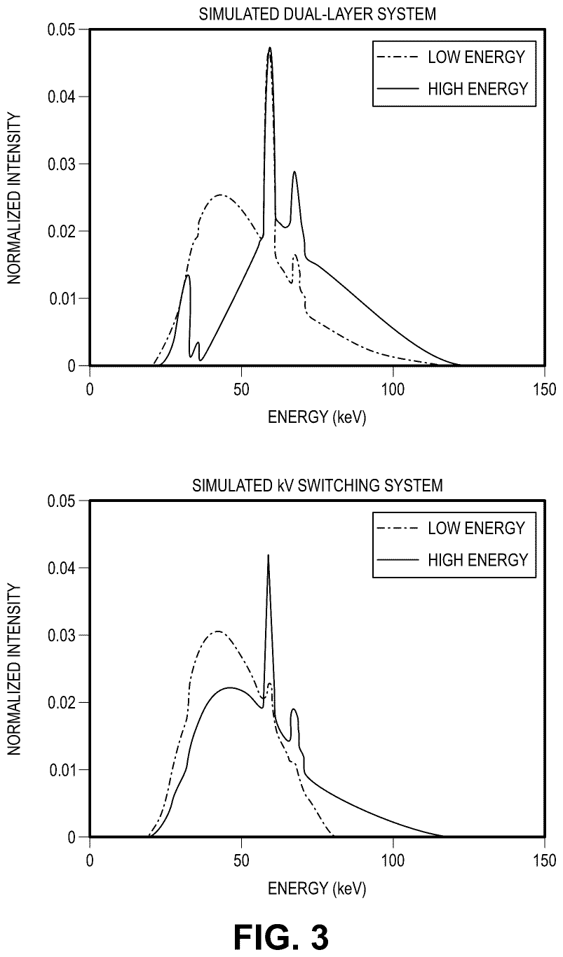

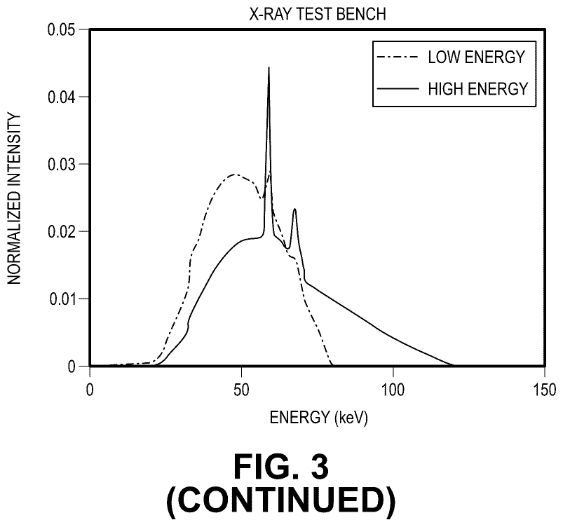

FIG. 3 shows normalized spectral sensitivities of the CT systems used in the simulation studies as well as the estimated sensitivities for the physical data experiments according to examples of the present disclosure.

Network Training: Network training is outlined in Algorithm 1. In one non-limiting example, a Residual Unet was employed as the backbone network of the diffusion model. Seven encoder/decoder blocks were configured and the number of channels was set to (16,32,64,128,256,512,512). Paired water and calcium images were concatenated to form the 2-channel input x₀. The diffusion process was discretized into T=1000 time steps, with the variance of added noise linearly increasing from β₁=1e⁻⁴ to β₁₀₀₀=0.02.25000 slices of the processed images are used for model training, and slices from patients excluded in the training dataset are reserved for evaluation. The model was implemented in the PyTorch framework and was trained using the Adam optimizer with a batch size of 32 and a learning rate of 10⁻⁴, and stopped after 200 epochs. Other modeling frameworks and optimizers can be used as would be appropriate for this technology.

### Evaluation

Simulation Study: Spectral DPS is studied on both dual-layer CT and kV-switching CT systems in a simulation study. Each system simulated 720 projections with Poisson noise equivalent to an exposure of 0.1mAs/view. The source-to-detector distance (SDD) was 1000 mm, and source-to-axis distance (SAD) 500 mm. Focal spot and detector blur were not modeled in this work. Reconstruction voxel size and detector pixel size was set to 0.8 mm and 1.0 mm, respectively. The simulated kV-switching system alternates the tube voltage between 80 kV and 120 kV every other view. In the duallayer system, the mismatch geometry of the two channels was modeled with a 5 mm gap between the two layers. FIG. 3 displays the normalized spectrum sensitivities of the investigated systems.

Physical Phantom Study: A phantom study was conducted by scanning an anthropomorphic lung phantom (PH-1, Kyoto Kagaku, Japan) on a cone-beam CT (CBCT) test bench system. Two sets of projections (720 views/set) were acquired at 80 kV and 120 kV with an exposure of 0.1mAs/view, which were then merged to mimic a dual-energy scan. The x-ray beam was vertically collimated to 2 cm width on the detector to minimize scatter, and the signal behind the collimator was used to estimate residual scatter, which was further subtracted from the raw projections.

Comparison Study: Image-Domain Material Decomposition (IDD): Filtered backprojection (FBP) was first applied to reconstruct spectral CT images, then a pixel-wise matrix inversion was utilized to decompose the attenuation maps into density maps:

$$[ \begin{matrix}{x}_{1} \\ ⋮ \\ {x}_{K}\end{matrix} ] = {M}^{- 1} [ \begin{matrix}{μ}_{1} \\ ⋮ \\ {μ}_{J}\end{matrix} ] \qquad ( 15 )$$

where [M]ⱼₖ=μⱼₖ is the effective mass attenuation of the k th basis material for the j th spectral channel. In this work, the number of bases and spectral channels is equal with K=J=2, and the 2×2 matrix M⁻¹ is pre-calibrated using 200 randomly selected slices in the training dataset through least-square minimization.

Model-based Material Decomposition (MBMD): In one non-limiting example, a one-step model-based decomposition can be used as described by S. Tilley, W. Zbijewski, and J. W. Stayman, “Model-based material decomposition with a penalized nonlinear least-squares CT reconstruction algorithm,” Phys. Med. Biol., vol. 64, no. 3, 2019, Art. no. 035005. The objective function is composed of data likelihood and quadratic penalty terms:

$${\underbrace{{‖ BS exp ( - Q A x ) - y ‖}_{{K}^{- 1}}^{2}}}_{Likelihood} + {\underbrace{{λ}_{w a t e r} R ( {x}_{w a t e r} ) + {λ}_{C a} R ( {x}_{C a} )}}_{Pena l t y} \qquad ( 16 )$$

This objective is minimized using a Separable Paraboloidal Surrogate (SPS) technique to form the water and calcium density maps. In this disclosure, 8000 iterations are used to obtain a reasonably converged solution. The material-specific regularization strength was tuned using a 2D sweep for λ_{water} and λ_{Ca}. The optimal combination was selected as the one with minimal RMSE.

InceptNet: Diffusion-based algorithms are compared with a non-diffusion-based image-domain material decomposition network (InceptNet). This network directly transforms FBPreconstructed spectral CT images into material images. In one non-limiting example, following the configuration suggested in H. Gong et al., “Deep-learning-based direct inversion for material decomposition,” Med. Phys., vol. 47, no. 12, pp. 6294-6309, 2020, the same network architecture, patch size, and loss weighting during the network training is adapted.

Conditional DDPM: A Conditional DDPM method for material decomposition was implemented for comparison. Instead of using the physics model to guide image generation, the spectral CT images reconstructed by FBP are concatenated with material images to condition the generation.

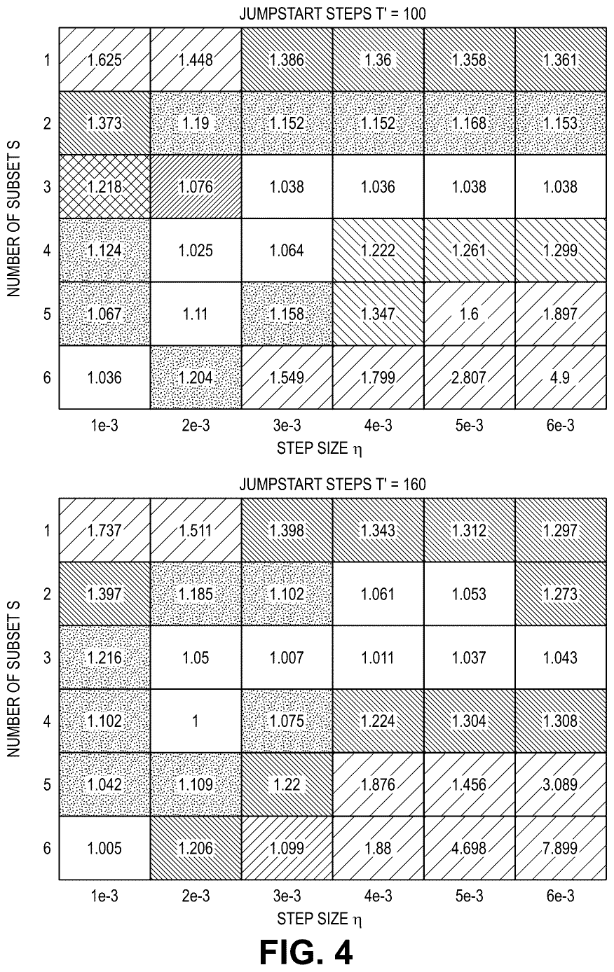

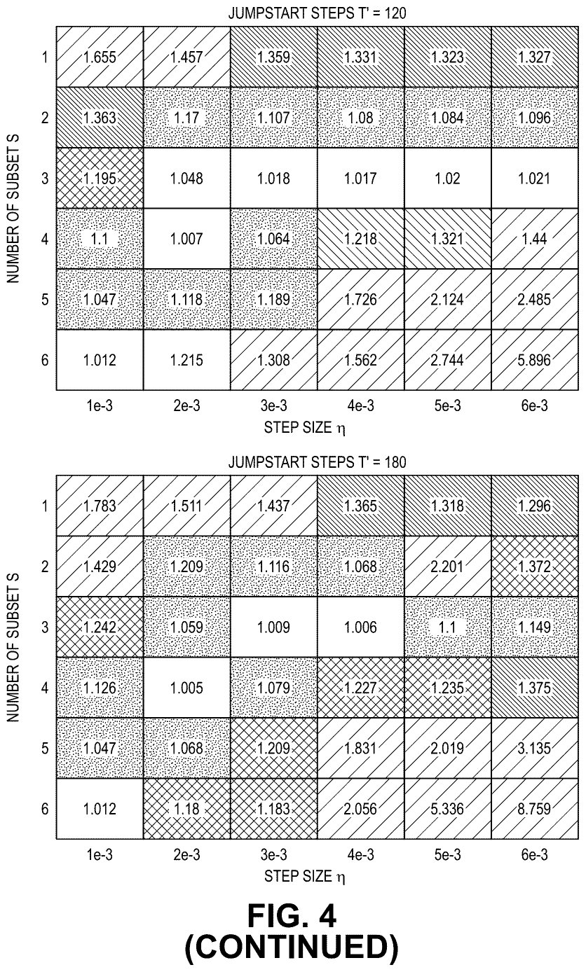

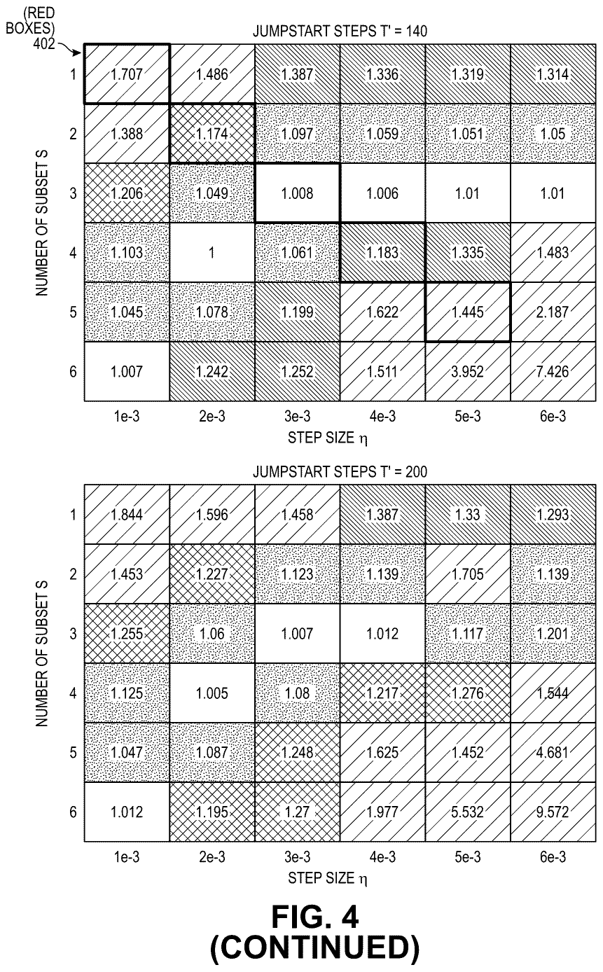

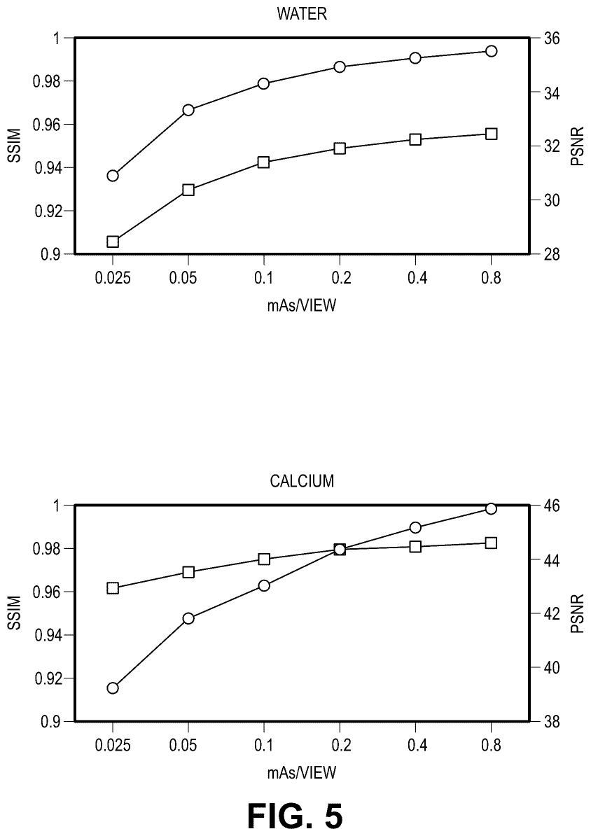

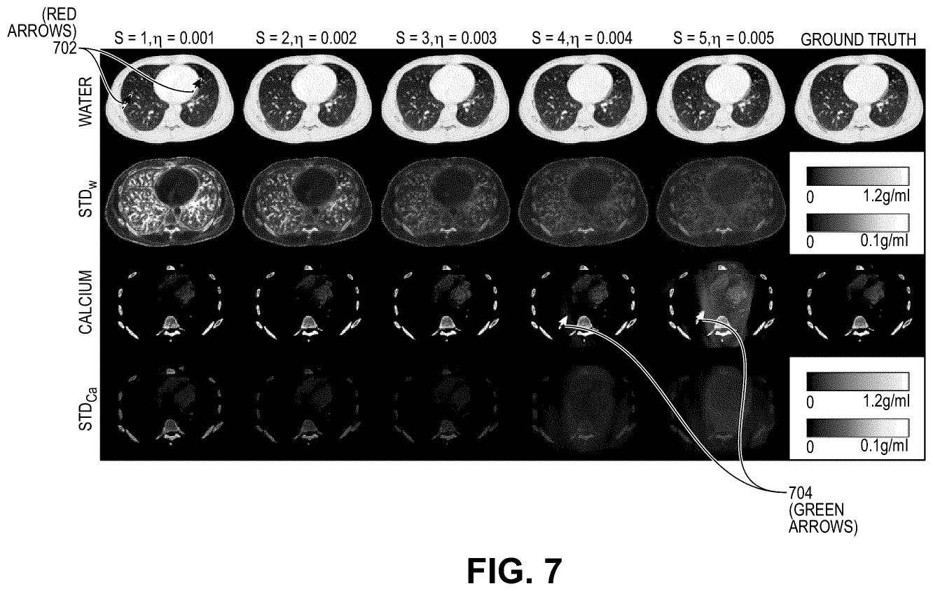

FIG. 4 shows STD maps for different combinations of hyperparameters according to examples of the present disclosure. All values were normalized by the minimal STD so that the lowest variability is unity. Parameter settings explored in FIG. 7 are outlined with boxes 402. FIG. 5 shows performance of parameter sets optimized at 0.1mAs/view on different dose levels according to examples of the present disclosure.

Baseline DPS: Baseline DPS was implemented as described in H. Chung et al., “Diffusion posterior sampling for general noisy inverse problems,” 2022, ar Xiv: 2209.14687 and Algorithm 2. In essence, the jumpstart, ordered subsets, and Adam optimizer strategies from Algorithm 3 were removed. The step size of gradient descent was determined as:

$${η}_{t} = η / {‖ {∇}_{{x}_{t}} log p ( y \vert {x}_{t} ) ‖}_{2} \qquad ( 17 )$$

The constant η is swept from 1 to 100, and selected the one with minimal STD over 32 samplings.

Since the conditional network trained on paired material images and FBP images is tailored to specific systems, both InceptNet and Conditional DDPM trained two separate neural networks for the dual-layer and kV-switching systems. For real-data decomposition, the kV-switching model trained on the simulated dataset was applied. In contrast, Baseline DPS and Spectral DPS, which apply unconditional training solely on the material images, train only one network that can be used for material decomposition on both dual-layer and kV-switching systems.

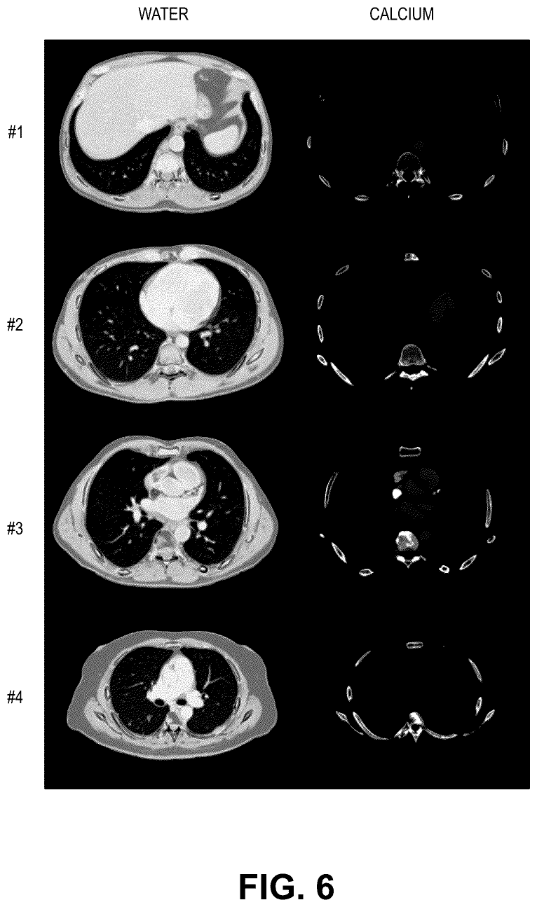

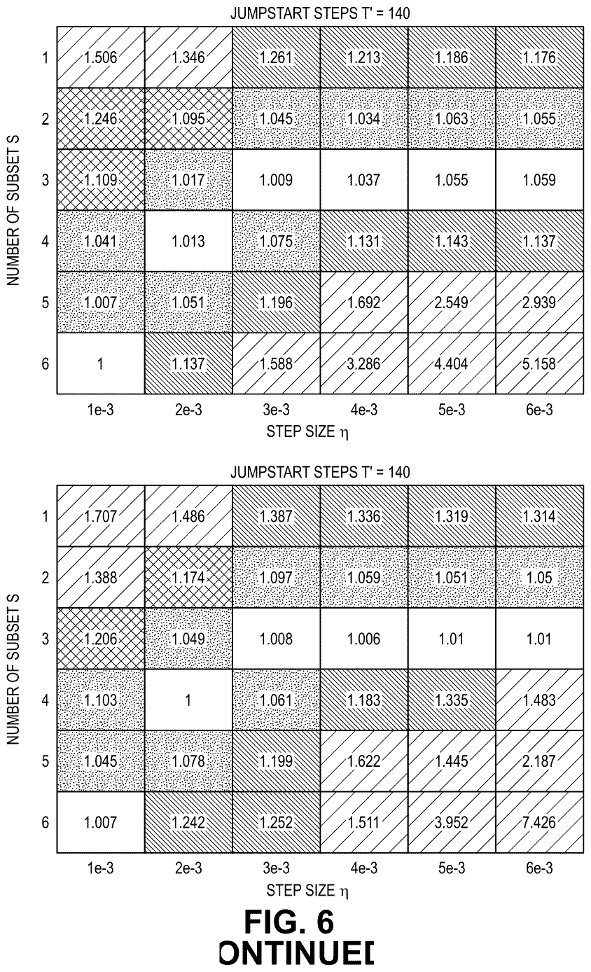

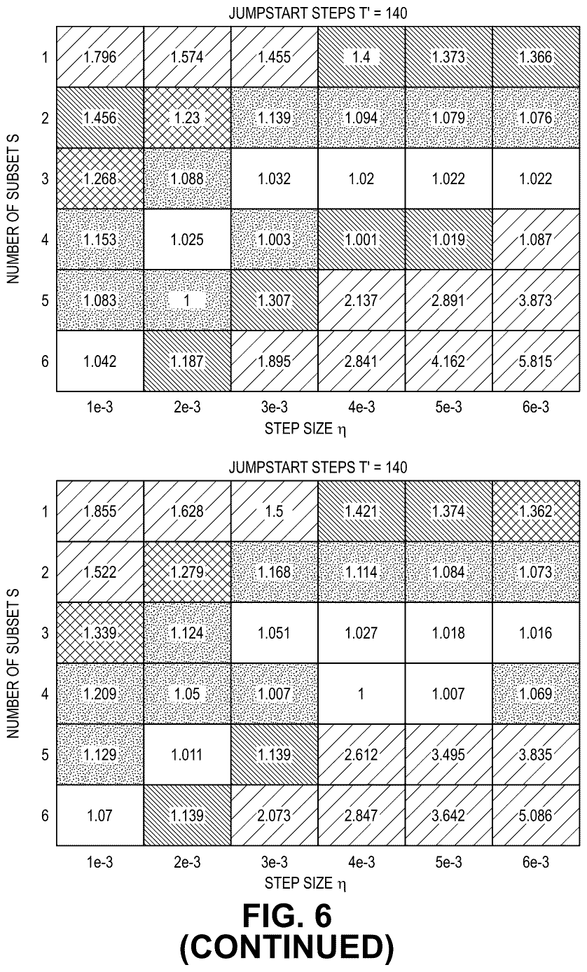

FIG. 6 shows normalized STD (right) for 4 slices (left) at different locations according to examples of the present disclosure.

Image Quality Metrics: Image STD was computed to evaluate the sampling variability and image bias was computed to quantify the numerical accuracy:

$$Bias = \frac{1}{M} {‖ \{ \hat{x} \} - x ‖}_{1} , \qquad ( 18 )$$

where the expectation was evaluated on 32 DPS samples from a common set of measurements. Root-mean-square error (RMSE), Peak signal-to-noise ratio (PSNR), and Structural similarity index measure (SSIM) are also computed to evaluate the image quality and explore the relationship between variability and other metrics:

$$RMS E = \{ \sqrt{M S E ( \hat{x} , x )} \} \qquad ( 19 a )$$

$$PSNR = \{ 10 \cdot {log}_{10} ( \frac{M A {X}_{x}^{2}}{M S E ( \hat{x} , x )} ) \} \qquad ( 19 b )$$

$$SSIM = \{ \frac{( 2 {μ}_{\hat{x}} {μ}_{x} + {c}_{1} ) ( 2 {σ}_{\hat{x} x} + {c}_{2} )}{( {μ}_{\hat{x}}^{2} + {μ}_{x}^{2} + {c}_{1} ) ( {σ}_{\hat{x}}^{2} + {σ}_{x}^{2} + {c}_{2} )} \} \qquad ( 19 c )$$

In the comparison study, the decomposition results are studied from different algorithms and focus on region-of-interests (ROIs) containing fine structures. The RMSE, PSNR, and SSIM are computed within each ROI to demonstrate decomposition performance.

FIG. 7 shows sample Spectral DPS results and the corresponding STD maps with different parameter settings according to examples of the present disclosure. STD is computed on 32 DPS samples from the same set of measurement. Arrows 702 show false features created for low S, η settings. Arrow 704 shows increased error for high S, η in the background.

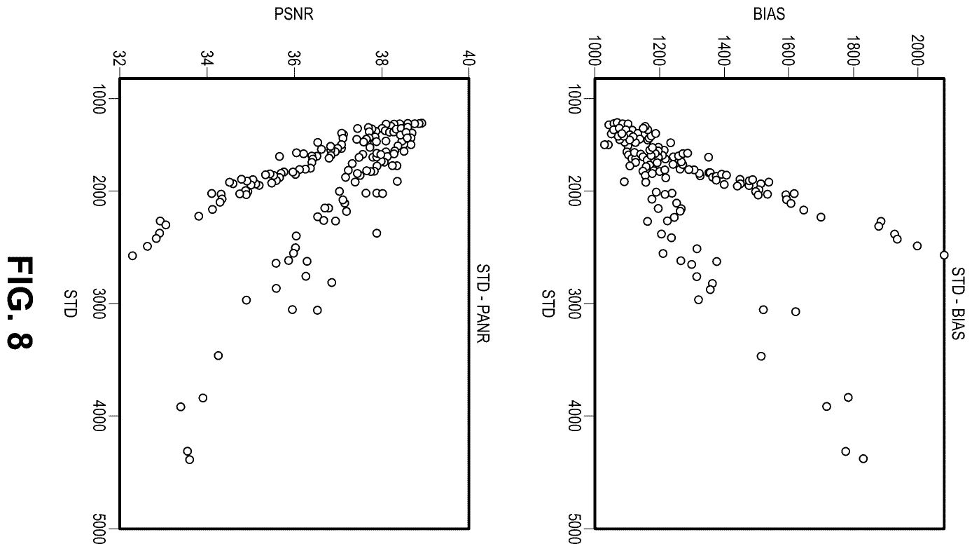

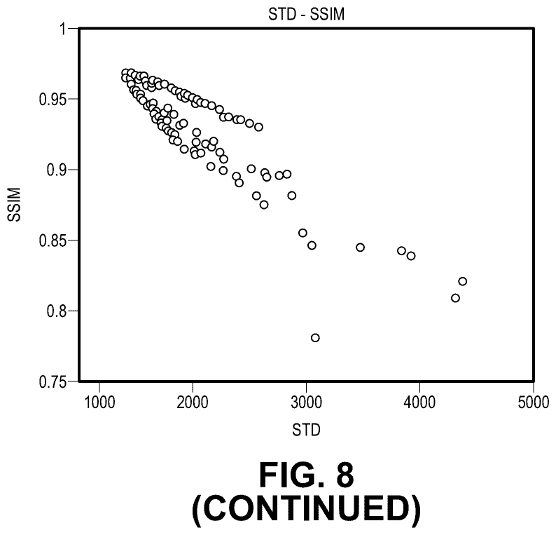

FIG. 8 shows a relationship between STD and bias/PSNR/SSIM according to examples of the present disclosure. Note that minimum STD is highly correlated with optimal image quality metrics.

Robustness Evaluation: Theoretically, DPS can handle arbitrary physical spectral models, which indicates its potential robustness to different imaging techniques. Based on the simulated dual-layer system, the robustness of diffusion-based algorithms (Conditional DDPM, Baseline DPS, Spectral DPS) ae evaluated by investigating their performance on systems operating at different tube voltages (110,115,120,125,130kVp).

Computational Cost Evaluation: Diffusion-based methods often require extensive sampling steps and the gradient computation in DPS can be associated with large memory consumption. The computational cost is evaluated in terms of both computation time and memory consumption by executing parallel 8 samplings on a workstation installed an AMD Ryzen 9 5950X CPU (AMD, Santa Clara, CA) and NVIDIA Geforce RTX 4090 GPU (NVIDIA, Santa Clara, CA). The forward/backward projector is implemented in a custom-written, PyTorch-compatible, CUDA-accelerated toolbox. All the other operators are executed within PyTorch framework with GPU acceleration.

### Results

### Spectral DPS Parameter Optimization

FIG. 9 shows material decompositions for simulated dual-layer CT system according to examples of the present disclosure. The quantitative metrics computed on the whole image are listed on the bottom. Display window: water (top): [0,1.2] g/ml, calcium (bottom): [0,0.2] g/ml, water (zoom in): [0,0.4] g/ml.

In this section, the results of parameter optimization for Spectral DPS in the simulated dual-layer CT system are presented.

Variability Analysis: A 3D parameter sweep for T′,n, and S for a single slice is first performed, with corresponding normalized STD heatmaps displayed in FIG. 4. The subplots for each number of time steps exhibits similar trends. There is a low-variability region extending from the top right to bottom left. For T′≥120, the difference in the minimal STD for optimal η, S is smaller than <1%. To further investigate how the parameter η, S selection affects the decomposition results, the decomposition and corresponding STD map of 5 different parameter settings with T′=140 are shown in FIG. 7. For small S, η (e.g. S=1, η=0.001), the STD map shows large variability particularly around the edges, as well as features that, while realistic, are inconsistent with the ground truth. Increasing S, η within a certain range led to significant STD reduction. However, when the optimal point was exceeded, i.e., S=3, η=0.003, the STD increases again. Unlike the high STD caused by variation in fine structures, this increase was due to background signal fluctuations.

Using the optimal parameter set (T′=140, S=4, η=0.002,0.1mAs/view), the performance of the disclosed DPS approach is investigated with the same parameter settings across different dose levels-specifically 0.025,0.05,0.1,0.2,0.4,0.8mAs/view. The quantitative results are shown in FIG. 5. The general trend indicates that image quality improves with increasing dose levels for both materials. With a quarter dose, Spectral DPS achieved SSIM of 0.9063 and 0.9625, and PSNR of 30.9176 and 39.2678 on water and calcium images, respectively. Though the SSIM and PSNR exhibits ˜4% and ˜10% reduction compared with normal dose, the DPS approach still surpasses the performance of other diffusion-based algorithms applied to the nominal dose of 0.1mAs/view, as in FIG. 9. In FIG. 6, the STD map of slices are plotted at different anatomical locations from liver (#1) to the main stem bronchus (#4), revealing that the heatmaps of different slices displayed similar trends. This suggests that parameters optimized on one slice or a group of representative slices can be reasonably applied to other slices, thereby eliminating the need for an anatomical-specific parameter tuning (at least for these thoracic CT). This consistency across slices underscores the robustness and generalizability of the parameter optimization process, streamlining the application of Spectral DPS.

Relationship Between STD and Other Metrics: Parameters optimized by minimizing STD alone reduces variability without taking other image properties into account. FIG. 8 shows the relationship between STD and other metrics, i.e., bias, PSNR, and SSIM computed on the same slice as that used in FIG. 4. Scatter plots between STD and the image quality metrics are formed by plotting these values over all cases in the 3D T′, η, S sweep. The scatter plots demonstrate that the settings with minimal STD also tend to produce images with minimal bias, maximal PSNR, and maximal SSIM. This indicates parameter optimization based on minimal STD also enhances decomposition accuracy and structural similarity. Based on this analysis, in this work, the hyperparameters of Spectral DPS are determined by minimizing the decomposition STD, ensuring that the optimization process not only reduces variability but also improves overall image quality and consistency. While these trends are based on the dual-layer system, our experiments shows that other dual-energy system, e.g. kV switching CT, exhibits similar behavior.

### Simulation Study Results

Spectral DPS is applied to two different spectral CT systems and compare the performance on imaging quality and computational cost with several alternate processing approaches.

Qualitative Analysis: A summary of material decompositions for dual-layer CT and kV-switching CT is presented in FIG. 9 and FIG. 10, respectively. For the dual-layer system, IDD showed a notable bias in both water and calcium images due to the linear approximation of spectral effects. The MBMD method significantly reduced background noise and enhanced the visibility of larger structures in the lung parenchyma and spinal regions. Baseline DPS further suppressed the decomposition noise, producing more realistic features in both material bases. However, noticeable deviations from the ground truth remained, especially in the lung and spine areas. In particular, note a small airway (arrow 902) in lung ROI was misrepresented. Though the Conditional DDPM accurately reconstructed most structures, an intensity bias was still observed on the spinal and cardiac regions (arrow 904, 1004) in the calcium image. InceptNet preserved most structures without obvious bias but exhibited streaky noise along high-attenuated projections. Spectral DPS provided superior recovery of features and textures as compared with the ground truth, accurately depicting the lung airway (arrow 902), costotransverse joint (arrow 904, 1004), and contrast enhancement (arrow 904, 1004).

FIG. 10 shows material decompositions for simulated kV-switching CT system according to examples of the present disclosure. The quantitative metrics computed on the whole image are listed on the bottom. Display window: water (top): [0,1.2] g/ml, calcium (bottom): [0,0.2] g/ml, water (zoom in): [0.8,1.2] g/ml.

The decomposition performance on the kV-switching system closely resembled that of the dual-layer system. To evaluate the decomposition performance in more challenging scenarios, ROI 3 is specified which contains low-contrast muscleadipose boundaries, and ROI 4 which contains low-density iodine-enhanced blood pools. As highlighted by the arrows 902, Baseline DPS reconstructed realistic but incorrect soft tissue boundaries on ROI 3. Conditional DDPM, while offering improvements over Baseline DPS, exhibited slight blurring and bias, which is also observed on the InceptNet results. Spectral DPS, on the other hand, accurately captured both the adipose boundaries and fine muscle details, providing a more faithful soft-tissue representation. On ROI 4, the noise level in IDD and MBMD results were too high to reliably visualize the contrast boundaries. While Baseline DPS generated somewhat accurate boundaries for the enhanced regions, it failed to capture the calcification in the bottom-right corner arrow 1004. Conversely, Spectral DPS not only reconstructed the overall shape of the enhanced region—albeit with slightly more noise than the Conditional DDPM—but also depicted the calcification with a distinct and clear boundary. InceptNet showed performance comparable to Spectral DPS, though it exhibited more streaky noise in the blood pools.

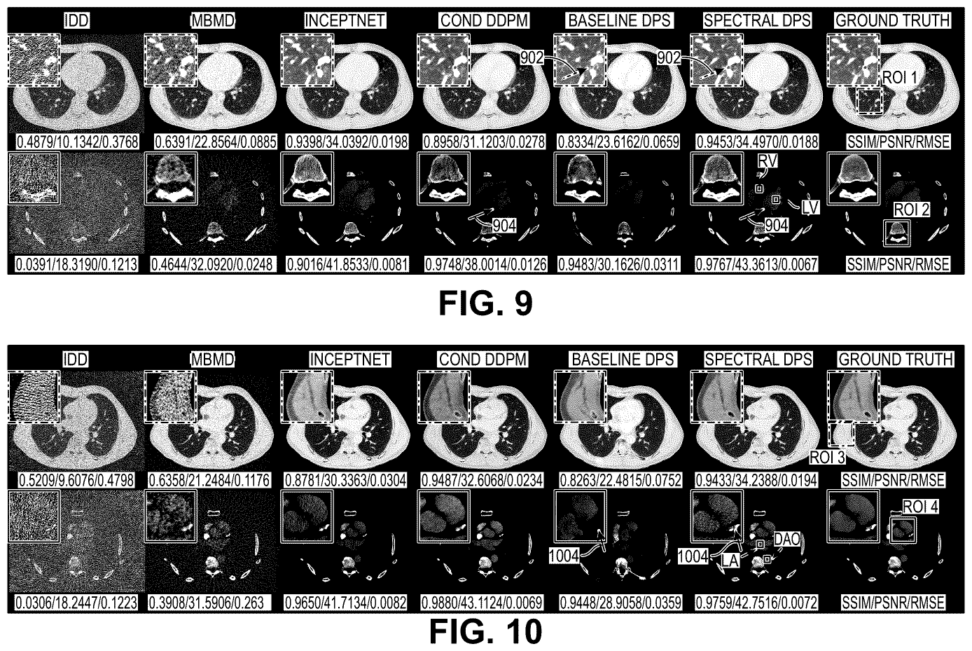

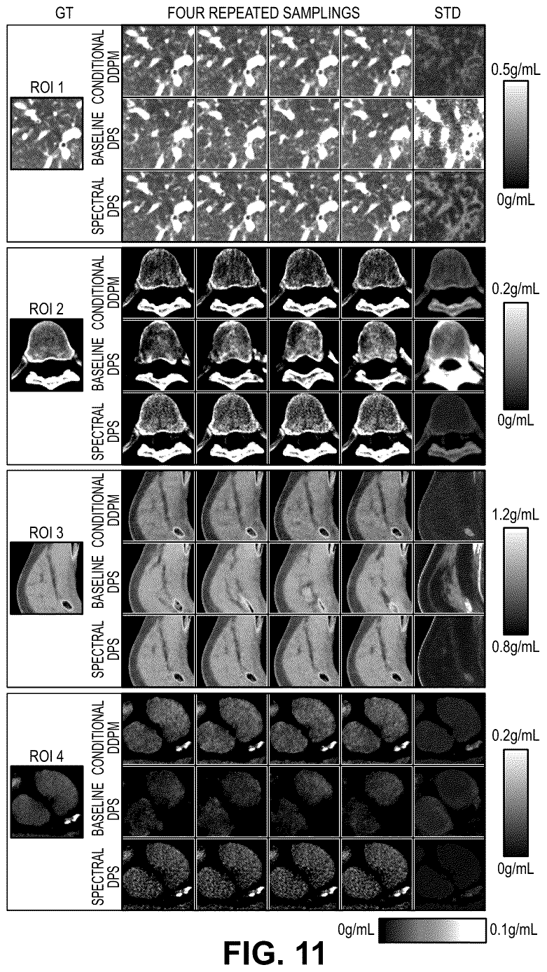

For diffusion-based methods, four repeated samplings with STD map computed from 32 samplings are shown in FIG. 11. Large samplings variation was observed in Baseline DPS results, which is caused by ineffective enforcement of data consistency. In contrast, Conditional DDPM achieved much more stable decompositions, with variations mainly confined to internal structural details. Spectral DPS demonstrated the lowest sampling variability overall, except around the vessel branches. Interestingly, despite showing noisier results in ROI4-likely due to measurement noise—Spectral DPS exhibited notably lower variability than Conditional DDPM. This suggests that Spectral DPS effectively incorporates measurement data to control the sampling variation, making it more robust in maintaining consistency across repeated samplings.

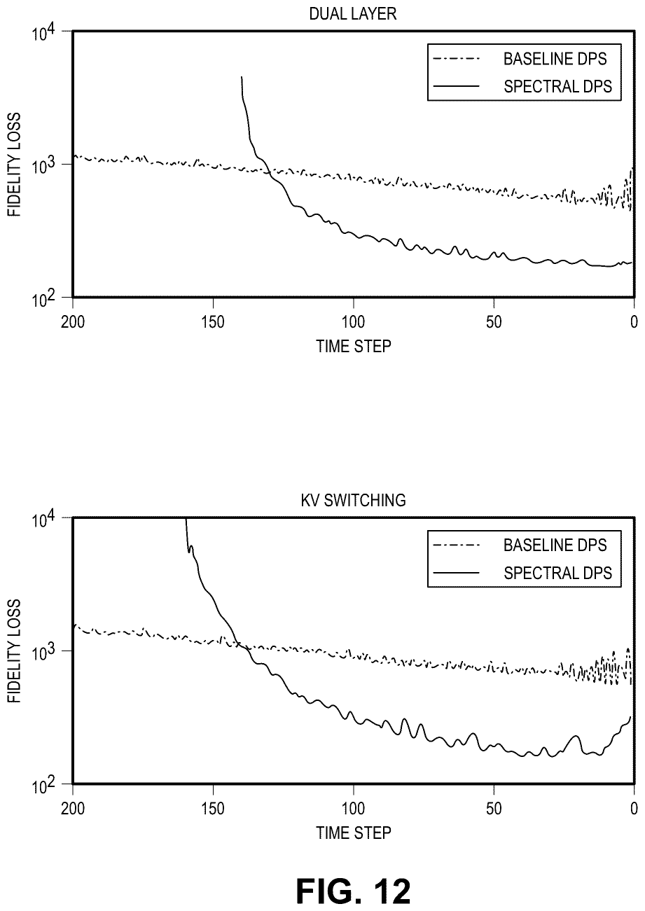

Quantitative Evaluation: Quantitative metrics computed across the entire image are displayed at the bottom of each image in FIG. 9 and FIG. 10. On the dual-layer system, Spectral DPS achieves the highest SSIM (0.9453 for water, 0.9767 for calcium) and PSNR (34.4970 for water, 43.3613 for calcium), along with the lowest RMSE (0.0188 for water, 0.0067 for calcium), outperforming all other competing algorithms. InceptNet performs comparably, but with slightly lower accuracy, while Conditional DDPM, despite good structural recovery, exhibits observable bias in the ROI images and lower performance in PSNR and RMSE. In the kV-switching system, Spectral DPS, though slightly outperformed by Conditional DDPM on SSIM, maintains excellent overall performance across all quantitative metrics. Baseline DPS, which utilizes the same physical model guidance as Spectral DPS, shows significantly lower imaging accuracy in both dual-layer and kV-switching systems. To investigate this phenomenon, the likelihood loss over the last 200 reverse sampling time steps are plotted in FIG. 12. The results reveal that, while the proposed Spectral DPS initially exhibits a higher fidelity loss compared to Baseline DPS, it demonstrates superior optimization speed and ultimately achieves a lower likelihood loss.

FIG. 11 shows multiple samplings of ROIs in FIG. 9 and FIG. 10 using diffusion-based algorithms according to examples of the present disclosure, where pixel-wise STD maps are shown in the right column. FIG. 12 shows likelihood loss (11) curves of the last 200 steps of the Baseline and Spectral DPS according to examples of the present disclosure.

Quantitative metrics computed on each ROI are summarized in Table II. Diffusion-based methods notably surpassed conventional IDD and MBMD algorithm on SSIM, highlighting their ability to generate more realistic images. Baseline DPS, due to the insufficient data consistency and considerable sampling variability, exhibits poor performance on STD, RMSE, and PSNR across all the ROIs. On ROI 1 (lung), Conditional DDPM achieved better RMSE, PSNR, and SSIM than Spectral DPS though the visual differences between the images were minimal, which may be attributed to the higher variation around the edges in Spectral DPS results. On ROI 4 (contrast), Spectral DPS and Conditional DDPM achieves similar RMSE and PSNR values, suggesting comparable imaging accuracy for these low-density structures. Structures in ROI 1 and ROI 4 are pretty low density. On ROI 2 and ROI 3 with higher density tissues, Spectral DPS showed superior performance, achieving a 21.01% and 14.96% STD suppression as well as 37.97% and 48.47% RMSE reduction compared to Conditional DDPM. This indicates that Spectral DPS can provide a more stable and accurate sampling process in these regions. This improved accuracy of Spectral DPS was also reflected in higher SSIM and PSNR values.

TABLE II
Performance of Material Decomposition Algorithms on the Simulated
Spectral CT Systems. Unit of STD and RMSE: g/ml)

| | | Algorithm | STD | RMSE | SSIM | PSNR |
|---|---|---|---|---|---|---|
| Dual | ROI 1 | IDD | NA | 0.3870 | 0.1076 | 8.2444 |
| layer | | MBMD | NA | 0.0897 | 0.4633 | 20.9373 |
| | | InceptNet | NA | 0.0214 | 0.9388 | 33.3720 |
| | | Cond DDPM | 0.0198 | 0.0281 | 0.8771 | 31.0006 |
| | | Baseline DPS | 0.0640 | 0.1066 | 0.5001 | 19.4404 |
| | | Spectral DPS | 0.0243 | 0.0325 | 0.8602 | 29.7403 |
| | ROI 2 | IDD | NA | 0.2172 | 0.0810 | 13.2602 |
| | | MBMD | NA | 0.0588 | 0.4896 | 24.6000 |
| | | InceptNet | NA | 0.0276 | 0.8065 | 31.1707 |
| | | Cond DDPM | 0.0119 | 0.0453 | 0.8592 | 26.8767 |
| | | Baseline DPS | 0.0501 | 0.1156 | 0.5860 | 18.7370 |
| | | Spectral DPS | 0.0094 | 0.0281 | 0.8895 | 31.0032 |
| kV | ROI 3 | IDD | NA | 0.4504 | 0.0681 | 6.9264 |
| switching | | MBMD | NA | 0.1167 | 0.2475 | 18.6534 |
| | | InceptNet | NA | 0.0420 | 0.7846 | 27.5436 |
| | | Cond DDPM | 0.0127 | 0.0359 | 0.8992 | 28.8873 |
| | | Baseline DPS | 0.0212 | 0.0415 | 0.7917 | 27.6183 |
| | | Spectral DPS | 0.0108 | 0.0185 | 0.9186 | 34.6303 |
| | ROI 4 | IDD | NA | 0.2205 | 0.0240 | 13.1284 |
| | | MBMD | NA | 0.0369 | 0.4036 | 28.6410 |
| | | InceptNet | NA | 0.0179 | 0.8033 | 35.1555 |
| | | Cond DDPM | 0.0075 | 0.0175 | 0.8782 | 35.2561 |
| | | Baseline DPS | 0.0075 | 0.0378 | 0.6259 | 28.4431 |
| | | Spectral DPS | 0.0054 | 0.0172 | 0.8125 | 35.2697 |

TABLE III
Mean Calcium Density (Unit: g/ml) on the Cardiac
ROIs Labeled in FIG. 9 and FIG. 10

| Algorithm | RV | LV | LA | DAo |
|---|---|---|---|---|
| IDD | 0.0014 | 0.0045 | 0.0372 | 0.0416 |
| MBMD | 0.0248 | 0.0271 | 0.0408 | 0.0466 |
| InceptNet | 0.0269 | 0.0407 | 0.0214 | 0.0372 |
| Cond DDPM | 0.0073 | 0.0118 | 0.0453 | 0.0596 |
| Baseline DPS | 0.0097 | 0.0178 | 0.0102 | 0.0297 |
| Spectral DPS | 0.0254 | 0.0346 | 0.0301 | 0.0475 |
| Ground truth | 0.0258 | 0.0363 | 0.0327 | 0.0486 |

Contrast agent quantification in the cardiovascular system is of significant clinical interest. In water/calcium decomposition, contrast enhancement appears as low-intensity signals in the calcium images. The mean values in four ROIs located in the left ventricle (LV), right ventricle (RV), left atrium (LA), and descending aorta (DAo), as indicated by the white boxes are evaluated in FIG. 9 and FIG. 10, to investigate the imaging accuracy in the cardiac region. The results are summarized in the Table III. Conditional DDPM and Baseline DPS, exhibit larger deviations on each ROI, consistent with observations in FIG. 9 and FIG. 10. InceptNet, while performing better than Conditional DDPM and Baseline DPS, shows a 29.91% bias in the LA. In contrast, the results demonstrated that Spectral DPS achieves values closest to the ground truth across all ROIs, particularly in the RV (0.0254 g/ml vs. 0.0258 g/ml) and DAo (0.0475 g/ml vs. 0.0486 g/ml), highlighting its superior accuracy in capturing subtle contrast variations.

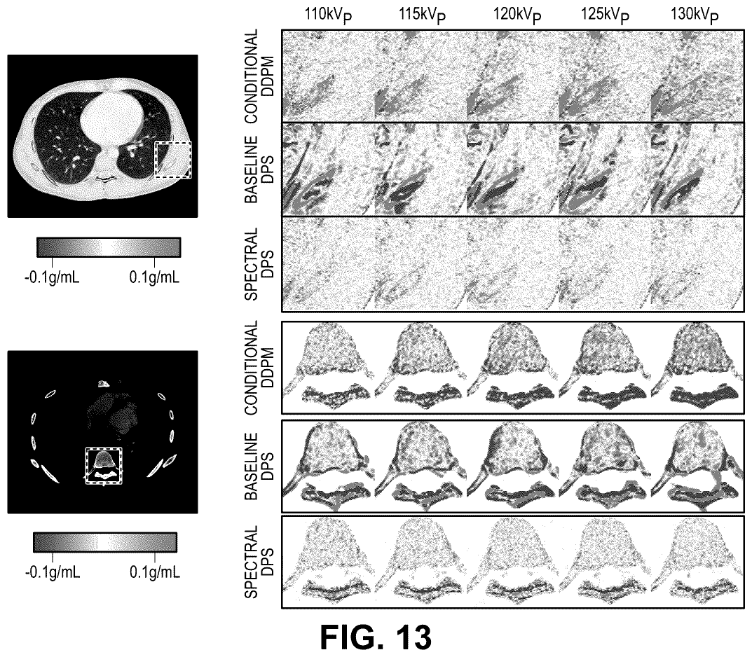

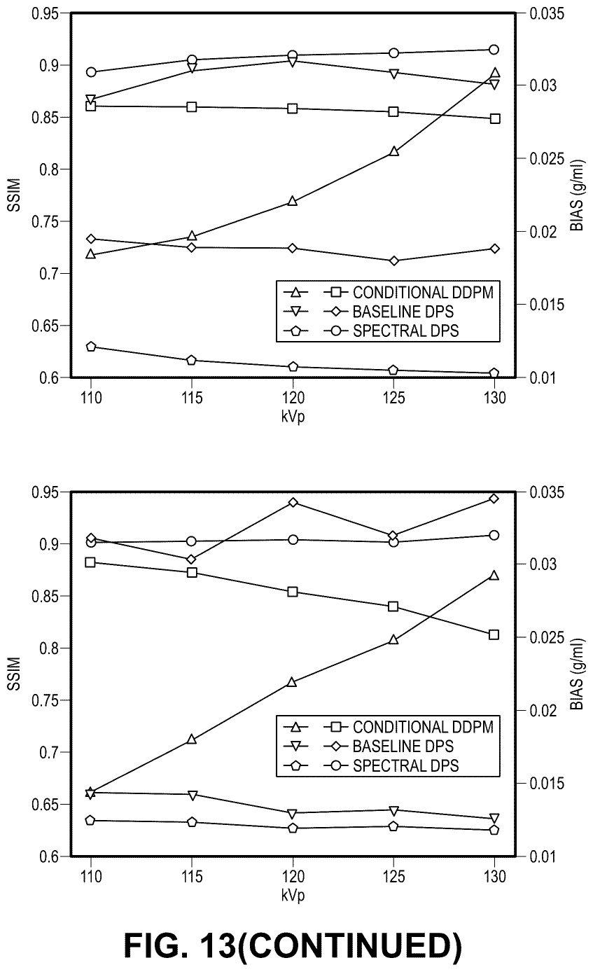

Robustness to Different Imaging Protocols: FIG. 13 presents the performance of diffusion-based methods under varying tube voltages. The conditional DDPM was trained on data simulated at 120 kVp. Interestingly, even under the same imaging condition as the training data, the difference images showed small biases, particularly around the cortical bone and on the soft tissues. This aligns with the findings from the previous section and may be attributed to that the image-domain decomposition cannot effectively handle the global beam-hardening effects. The bias in Conditional DDPM became more pronounced as the kVp increases. Quantitative analysis reveals that 10 kVp increase on tube voltage can lead to 39.75% and 33.45% larger bias on the water and calcium ROIs, respectively. Conversely, the bias decreases with lower kVp, which may be due to the higher attenuation at lower energy levels compensating for some of the bias in Conditional DDPM. Spectral DPS consistently outperformed Conditional DDPM in terms of SSIM and bias across all kVp settings. Additionally, the bias and SSIM curves for Spectral DPS remain relatively flat, indicating its robustness across different imaging protocols. Quantitative analysis further shows that as the tube voltage varied between 110 kVp and 130 kVp, the water and calcium bias for Spectral DPS fluctuated by only 5.17% and 15.24%, respectively. In contrast, Conditional DDPM exhibited remarkably larger variations of 103.68% and 67.41%. This further demonstrated significantly enhanced robustness of Spectral DPS over Conditional DDPM.

FIG. 13 show diffusion-based decomposition results under different tube voltages according to examples of the present disclosure, where the left part illustrates the selected ROIs, middle part displays the error maps of different decomposition algorithms, and the right part shows how the quantitative metrics change with the varied tube voltages.

Computational Cost: Computational cost of diffusion-based algorithm is summarized in Table IV. Spectral DPS was evaluated using the optimized parameter settings: S=4, T′=140 for the dual-layer system and S=5, T′=140 for the kV-switching system. Baseline DPS, due to the need to compute gradients through the neural network, consumes approximately three times more memory than the other diffusion-based algorithms. In contrast, Spectral DPS and Conditional DDPM have comparable memory usage. One of the advantages of Spectral DPS lies in its efficient “jumpstart” strategy, which allows it to skip over 85% of the time steps in the diffusion process, significantly reducing the computational burden. As a result, most of the computation for Spectral DPS lies in the likelihood update, rather than the diffusion sampling itself. Overall, Spectral DPS achieved an average decomposition speed of 8.49 s/slice and 5.64 s/slice for dual-layer and kV-switching system, respectively, which represents a time reduction of 23.01% and 47.92% for these two spectral systems compared with Conditional DDPM. These results demonstrated that Spectral DPS not only offers superior imaging performance but also provides a significant computational advantage, making it a more practical and efficient choice for clinical applications where both accuracy and speed are critical.

TABLE IV
Computational Cost of Parallel 8 Samplings
Using Different Diffusion-Based Algorithms

| | | Cond DDPM | | Baseline DPS | | Spectral DPS | |
|---|---|---|---|---|---|---|---|
| Dual layer | Likelihood | NA | | 451.03 | s | 55.46 | s |
| | update | | | | | | |
| | Diffusion | 87.99 | s | 86.64 | s | 12.48 | s |
| | sample | | | | | | |
| | Total time | 87.99 | s | 537.67 | s | 67.94 | s |
| | Video memory | 4.49 | GB | 15.52 | GB | 4.62 | GB |
| kV switch | Likelihood | NA | | 260.19 | s | 32.75 | s |
| | update | | | | | | |
| | Diffusion | 86.56 | s | 86.97 | s | 12.33 | s |
| | sample | | | | | | |
| | Total time | 86.56 | s | 347.16 | s | 45.08 | s |
| | Video memory | 4.49 | GB | 12.16 | GB | 4.53 | GB |

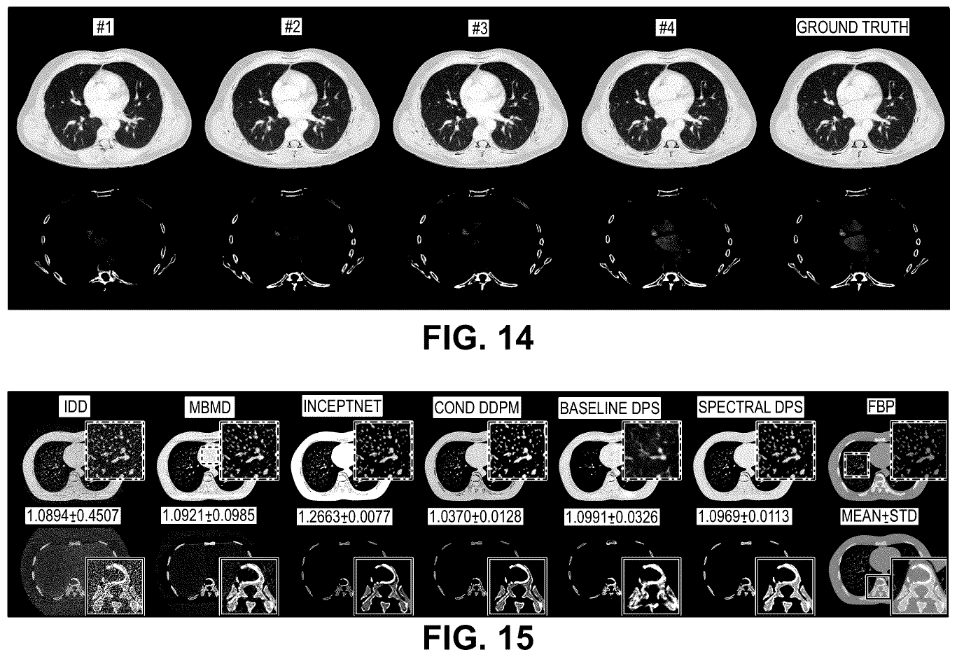

Ablation Study: The ablation study evaluates the effectiveness of different enhancing strategies-Jumpstart, Simplified Jacobian, and Multi-step optimization—on the simulated dual-layer CT system. As summarized in Table V and illustrated in FIG. 14, computational cost and imaging quality are analyzed across four configurations (#1 to #4). The #1 and #4 represent the Baseline DPS and Spectral DPS, respectively. Baseline DPS (#1), which lacks any enhancement, required the highest computational consumption with 15.52 GB memory and 546.95 s runtime. Introducing Jumpstart (#2) significantly reduced runtime to 77.92 s without affecting memory usage. By bypassing Jacobian computation, Simplified Jacobian (#3) further decreased 25.58% memory and 13.38% time usage. The full combination in Spectral DPS (#4) significantly reduced the memory consumption to 4.62 GB by leveraging the ordered subsets strategy, which also compensates for the additional time required for the multi-step iterations. This approach enables multistep iterations without compromising computational efficiency. In terms of image quality, the jumpstart strategy significantly enhanced decomposition accuracy and stability, as evidenced in both visual results and quantitative metrics. Using #2 as a reference, Simplified Jacobian demonstrated a moderate impact on PSNR and RMSE, while remarkably improving the SSIM and STD. Although #2 and #3 improve the depiction of overall anatomical structures, subtle details in the lung parenchyma and soft tissue boundaries still deviated from the ground truth. The high STD indicates a large variability across the posterior samplings. Multi-step optimization (#4), which can effectively maximize the data consistency, substantially improves the image quality for both basis materials, achieving the highest PSNR and SSIM, along with the lowest RMSE and STD. These results highlight the synergistic benefits of combining all three strategies.

TABLE V
Ablation Study of Different Enhancing
Strategies on Dual-Layer CT System

| | #1 | #2 | #3 | #4 |
|---|---|---|---|---|
| Jumpstart | — | ✓ | ✓ | ✓ |
| Simple Jacobian | — | — | ✓ | ✓ |
| Multi Step | — | — | — | ✓ |

Computational Cost

| | | | | |
|---|---|---|---|---|
| Memory(GB) | 15.52 | 15.52 | 11.55 | 4.62 |
| Time(s) | 546.95 | 77.92 | 67.34 | 66.76 |

Water Results

| | | | | |
|---|---|---|---|---|
| PSNR | 22.7399 | 26.7697 | 26.1982 | 34.2519 |
| SSIM | 0.7603 | 0.7661 | 0.8518 | 0.9465 |
| RMSE(g/ml) | 0.0730 | 0.0459 | 0.0490 | 0.0194 |
| STD(g/ml) | 0.0196 | 0.0150 | 0.0151 | 0.0071 |

Calcium Results

| | | | | |
|---|---|---|---|---|
| PSNR | 28.6556 | 35.3319 | 35.4371 | 42.3465 |
| SSIM | 0.9310 | 0.9370 | 0.9699 | 0.9779 |
| RMSE(g/ml) | 0.0370 | 0.0171 | 0.0169 | 0.0076 |
| STD(g/ml) | 0.0196 | 0.0021 | 0.0016 | 0.0015 |

All the metrics are computed on the 8 samplings conditioned on the same measurements.

FIG. 14 show ablation study results according to examples of the present disclosure. #1 to #4 used different combination of the proposed enhancing strategies as detailed in Table V. Top and bottom are water ([0,1.2] g/ml) and calcium ([0,0.2] g/ml) images, respectively.

### Physical Phantom Study Results

FIG. 15 shows decomposition results for the anthropomorphic lung phantom according to examples of the present disclosure. As discussed in the variability analysis, multiple samplings using the real measurements and selected the parameters are performed which minimizes the sampling STD. Since ground truth is not available for this case, individual energy channel CT images are provided as a reference, and used bone as basis material instead of calcium. A small regularization term was added to MBMD to control noise while approximating an unbiased maximum likelihood estimator. To quantify errors, a homogeneous area marked by a red box was used for analysis.

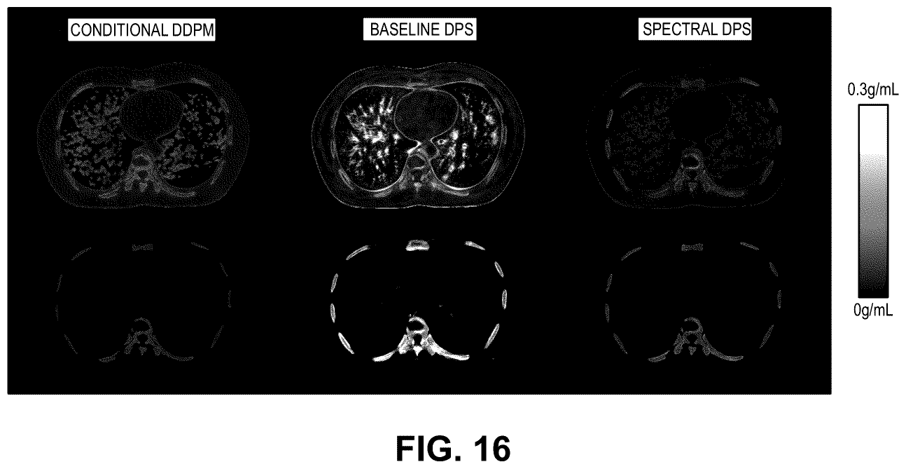

Using single-energy FBP image as a reference, it is evident that Spectral DPS effectively preserved most of the lung branches in the water image and accurately delineated the boundary of the cortical bone in the bone image. Both IDD and MBMD, however, exhibited extensive decomposition noise. In the homogeneous heart region, the difference of mean value among MBMD, Baseline DPS, and Spectral DPS was less than 1%, indicating only minor discrepancies in mean estimation. Spectral DPS achieved a significant STD reduction of 65.34% compared to Baseline DPS. Additionally, it is noted that Baseline DPS had a tendency to introduce false structures in the homogeneous phantom, particularly around the heart boundaries and the water/fat boundaries in the chest wall. In contrast, Spectral DPS more reliably visualized those homogeneous regions. InceptNet and Conditional DDPM, which were trained with a spectrum different from that of the bench system, exhibited remarkably biased intensity on both soft tissue and bone structures. FIG. 16 shows the STD maps of the diffusion-based samplings according to examples of the present disclosure. Baseline DPS exhibited considerable uncertainty in capturing finer details, as evidenced by the bright areas in the rib cage and lungs. In contrast, Conditional DDPM effectively controlled the sampling variation, while Spectral DPS further reduced the STD around the vessel branches, substantially enhancing the stability and reliability of the decomposition for subtle structures.

### Discussion and Conclusion

As described above, a spectral diffusion posterior sampling framework, Spectral DPS, for multi-material decomposition are disclosed. One of the advantages of DPS is to decouple network training from specific system configurations, allowing a one-time training for different applications. This flexibility has been validated through the simulation study on the kV-switching and the dual-layer system which have considerably dissimilar spectral sensitivities. Comparison studies revealed that Spectral DPS, which relies on unconditional training, can outperforms a Conditional DDPM trained on specific imaging condition in term of imaging accuracy and variability. The experiments with different imaging techniques further demonstrated the robustness advantage of Spectral DPS over Conditional DDPM.

FIG. 15 shows material decomposition on the bench CBCT system according to examples of the present disclosure. The mean and STD computed on a homogeneous region (red box) and are listed below water image. A single-energy FBP reconstruction is shown in the last column to provide a low-noise reference of the real phantom structure. Display window: water (top): [0.2,1.2]g/ml, bone (bottom): [0,0.5]g/ml, FBP: [0,0.04]mm−1.

FIG. 16 shows a STD map of diffusion-based algorithms evaluated on 32 posterior samplings from bench data, where the top and bottom row represents water and bone STD, respectively, according to examples of the present disclosure.

Moreover, the evaluation of Spectral DPS are extended to a physical system and an anthropomorphic phantom, whose partially realistic features do not perfectly align with the trained prior distribution. Spectral DPS successfully depicts the homogeneous soft tissue in the real phantom without notable hallucinations. This behavior demonstrates that Spectral DPS can maintain a reasonable balance between prior knowledge and measurement information, which enhances its capability of accommodating out-of-distribution samples. Such adaptability further validates the robustness of Spectral DPS as well as its potential applications in various clinical settings.

Spectral DPS incorporated several strategies from our previous work to further stabilize and accelerate the decomposition. The proposed Spectral DPS has demonstrated significantly improved stability and imaging accuracy compared to alternate approaches across both simulated dual-layer and kV-switching systems, as well as physical bench CBCT data. The modified strategies borrow significantly from prior model-based algorithm developments. For example, model-based material decomposition often necessitates extensive iterations to achieve convergence, primarily due to its inherent ill-conditioned nature. For the same reason, Baseline DPS with a naive gradient descent optimizer struggles to effectively incorporate physics information into the decomposition process, resulting in significant variability in the outcomes. The jumpstart sampling, initiated from image-domain decomposition, provides an excellent initialization for the reverse process and significantly shortens the number of sampling steps and reduces the potential for divergence caused by the stochastic sampling processes. Additionally, the integration of the Adam optimizer with ordered subset strategy effectively enhances data consistency. While these improvements are substantial, using denoised IDD initialization could further reduce the required sampling steps by narrowing the gap between IDD results and the prior distribution. Potential denoising techniques include general image denoising algorithms, material decomposition-specific algorithms, and recent deep-learning-based denoising algorithms. Moreover, exploring other sophisticated classic optimizers, such as SPS and the preconditioned algorithm, may potentially accelerate convergence even further. The impact of such advanced denoising methods and optimization algorithms on Spectral DPS is left for future investigation.

One observation in this disclosure was that a careful parameter optimization seeking minimized STD can not only significantly reduce DPS variability, but that minimum STD is correlated with improved performance on other metrics quantifying the decomposition accuracy, e.g., PSNR and SSIM. Also, the optimal parameters appeared to be similar for different anatomical slices. This consistency may obviate the need for fine tuning, streamlining the decomposition process and enhancing overall efficiency. Future efforts will investigate if such optimal parameters extend to more diverse anatomical targets beyond thoracic CT. Besides, the network architecture and configuration can have an impact on the diffusion sampling quality with potential effects on the DPS variability.

Some clinical applications require further material separation for precise quantification of water, calcium, and exogenous contrast agent, necessitating the decomposition of three or more basis materials. While the above disclosure primarily describes two-material decomposition, the above techniques can be extended to spectral DPS with more materials as described below. For example, photon-counting CT can provide additional spectral channels (i.e., energy bins) to permit estimation of more material bases.

### Volumetric Spectral CT

This study establishes a foundation for advancing one-step material decomposition in volumetric spectral CT.

Volumetric Material Decomposition Using 2D Diffusion Model and 3D Physics Model: As described above, the superior performance of Spectral DPS in a 2D CT scenario is presented. However, extension to 3D poses challenges including large memory requirements for training a 3D score network and a high computational burden for evaluating the 3D forward model due to spectral effects modeling. To address the first issue, a common strategy of training a 2D score network and processing the 3D volume slice-by-slice is adopted. To mitigate discontinuities between adjacent slices, a TV penalty is added along the longitudinal direction in the MBIR step:

$$ℒ = {‖ S exp ( - Ax ) - y ‖}_{{K}^{- 1}}^{2} + {β}_{T V} {‖ {\partial }_{z} x ‖}_{1} \qquad ( 10 )$$

For the second issue, the compressed forward model and an ordered subset strategy are utilized to enable volumetric material decomposition with reasonable computational cost. The overall decomposition algorithm is summarized in Algorithm 4. Eight subsets are used and other hyperparameters are optimized as discussed in the 2D work above.

Algorithm 4 Volumetric Spectral DPS

```
  1: Q_{c}, S_{c}: compressed spectrum and mass attenuation
  2: T/T′ = 1000/140: training/sampling time steps
  3: ϵ_{θ}: 2D score network
  $4 : {\hat{x}}_{0}^{i} : image - domain decomposition$
  5:
  6: # Adam optimizer
  7: η = 0.003, γ₁ = 0.9, γ₂ = 0.999: step size, momentum coeff
  8:
  9: # Ordered subset
10: S = 8: number of subset
11: (Aₛ, yₛ): subset forward projector and spectral measurements
12:
13: # Reverse sampling initialization
14: ϵ ~ [symbol] (0, I)
$15 : {x}_{{T}^{′}} = {\hat{x}}_{{T}^{′}}^{i} = \sqrt{{\overline{α}}_{{T}^{′}}} {\hat{x}}_{0}^{i} + \sqrt{1 - {\overline{α}}_{{T}^{′}}} ϵ$
16:
17: # Posterior sampling
18: for t = T′ to 1 do:
19: # Diffusion step:
20: Loop each slice of xₜ:
21: z ~ [symbol] (0, I)
$22 : {\hat{x}}_{0} = \frac{1}{\sqrt{\text{?}}} ( {x}_{t} - \sqrt{1 - {\overline{α}}_{t}} {ϵ}_{θ} ( {x}_{t} , t ) )$
$23 : {x}_{t - 1}^{′} = \frac{\sqrt{\text{?}} ( 1 - \text{?} )}{1 - \text{?}} {x}_{t} + \frac{\sqrt{\text{?}} {β}_{t}}{1 - \text{?}} \text{?} + {σ}_{t} z$
24:
25: # MBIR step:
26: \hat{x}′₀ = \hat{x}₀
27: for s = 1 to S do:
$28 : {\hat{x}}_{0}^{′} = Adam ( {\hat{x}}_{0}^{′} , S {∇}_{{\hat{x}}_{0}^{′}} {‖ {S}_{c} exp ( - {Q}_{c} {A}_{s} {\hat{x}}_{0}^{′} ) - {y}_{s} ‖}_{{K}^{- 1}}^{2} + {β}_{TV} {‖ {\partial }_{z} x ‖}_{1} )$
29: end for
$30 : {x}_{t - 1} = {x}_{t - 1}^{′} - {\hat{x}}_{0} + {\hat{x}}_{0}^{′}$
31: end for
$\text{?} \text{indicates text missing or illegible when filed}$
```

Diffusion Model Training: To create a diverse dataset for training the generative model, chest scans from multiple public CT datasets, i.e., Lymph, Mayo2016, Kits2023, Covid2020, are collected. 30488 slices from 370 patients are picked for training while reserved 7086 slices from other 91 patients for validation and testing. Details on dataset processing, score network configuration, and network training can be found in X. Jiang, G. J. Gang, and J. W. Stayman, “Multi-material decomposition using spectral diffusion posterior sampling,” arXiv preprint arXiv: 2408.01519, 2024.

### Evaluation

A two-basis 3D phantom was generated from a single patient in the Lymph dataset. The volume dimensions were 512×512×256 voxels with a voxel size of 0.8×0.8×1.0 mm³. A spectral CT system was simulated using a dual-layer flatpanel detector with 1024×384 pixels and a pixel size of 1 mm². For data generation, a circular scan with 720 projections over 360°, an exposure of 0.1mAs/view, and 150 energy bins with 1 keV spacing were simulated using our projector tools described in X. Jiang, G. J. Grace, and J. W. Stayman, “Ctorch: Pytorch-compatible gpu-accelerated auto-differentiable projector toolbox for computed tomography,” arXiv preprint arXiv: 2503.16741, 2025.

The disclosed algorithm is compared with image-domain decomposition (IDD), a non-diffusion material decomposition network (InceptNet), and a conditional-DDPM-based material decomposition (CDDPM). InceptNet directly maps FBP-reconstructed images to material images, whereas CDDPM conditions the generation process using both FBP and material images. Both methods process 3D volumes slice-by-slice using 2D networks. All algorithms were tested on a PC (AMD Ryzen 9 5950X CPU, NVIDIA Geforce RTX 4090 GPU), leveraging a custom CUDA-accelerated toolbox for forward projection and PyTorch built-in GPU acceleration.

### Results

### Hyper-parameter C Selection

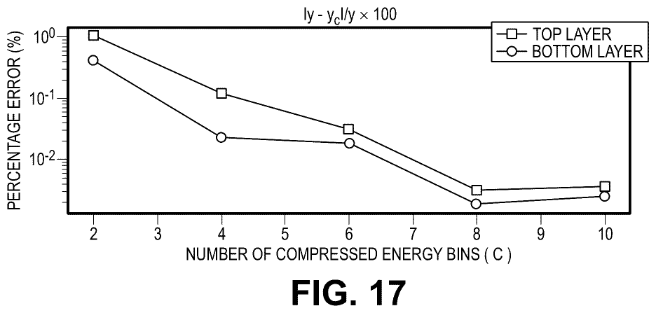

FIG. 17 shows percentage error of noiseless projections simulated with optimized ŝ and \hat{q} of different compressed energy bins according to examples of the present disclosure. For both layers, C≤8 can achieve an error of <0.01%.

As described in Sec II-A the compressed spectrum and mass attenuation (ŝ, \hat{q}) are optimized for different number of bins (C). The percentage error for the predicted projections on the l grid is shown in FIG. 1. As C increases, the projection error decreases, reaching below 0.01% when C≥8. Further increasing C to 10 yields no significant improvement. Therefore, C=8 is used in the compressed forward model.

### Accuracy of Compressed Forward Model

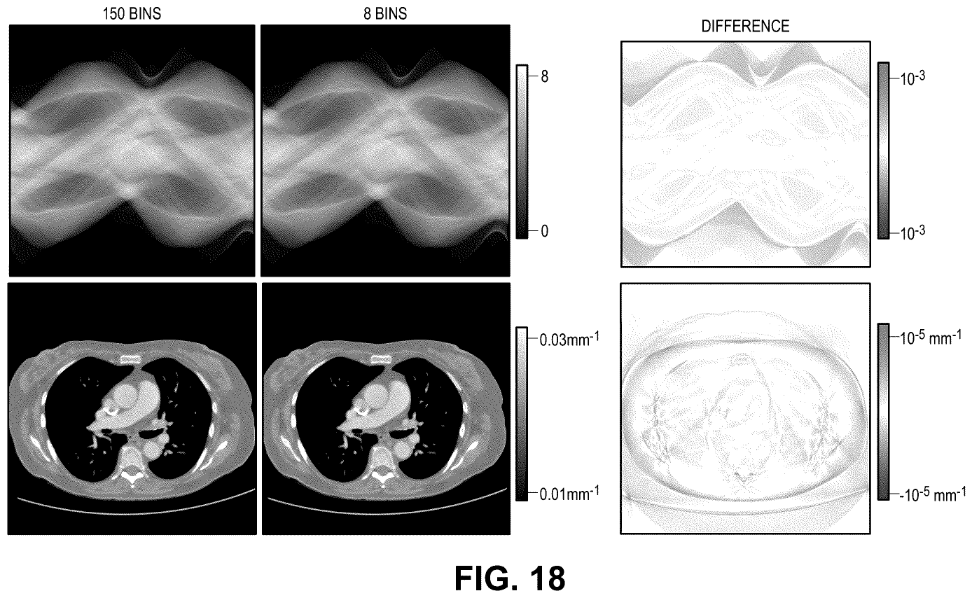

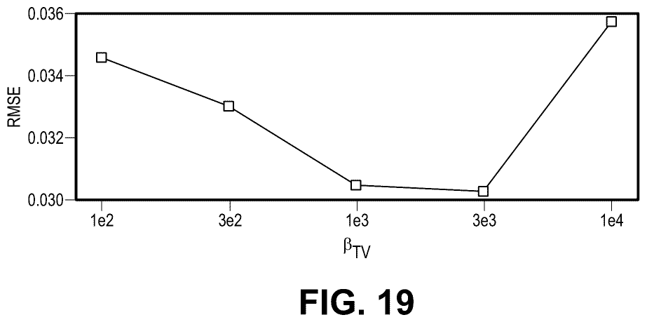

FIG. 18 shows sinogram and FBP images generated from noiseless projection simulated via discretized model (150 bins) and compress model (8 bins) according to examples of the present disclosure. The error maps with narrow display window indicates an ignorable error with compressed forward model. FIG. 19 shows reconstruction RMSE vs. regularization strength β_{TV} according to examples of the present disclosure. The compressed forward model is further validated on a digital phantom. FIG. 18 shows sinogram data and corresponding FBP images for noiseless projections computed using the 150 bin discretized model and the 8 bin compressed model. The error map, displayed with a narrow window setting, shows only small errors for the compressed model. A small background bias is observed in the reconstructed image, however the 8-bin model achieves an error of less than 0.1% within the patient.

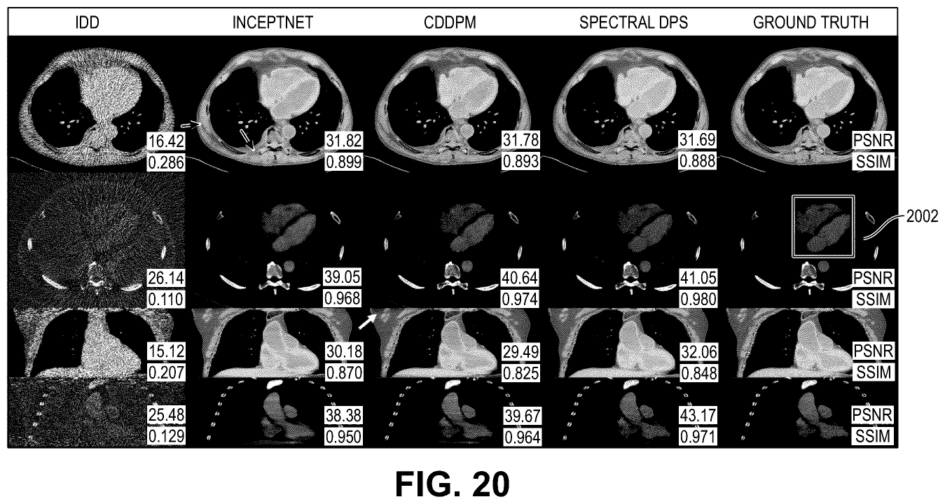

FIG. 20 shows a 3D material decomposition results using different algorithms according to examples of the present disclosure. The first and third rows are the water images, [0.8,1.2]g/ml, second and last rows are the calcium images, [0.0,1.2] g/ml. PSNR and SSIM are labeled on the bottom-right corner. Box 2002 indicates the cardiac ROI for contrast quantification analysis.

### Volumetric Material Decomposition

FIG. 19 shows the RMSE of the entire reconstructed volume as a function TV regularization strength (β_{TV}) according to examples of the present disclosure. The optimal β_{TV} was determined to be 3×10³. FIG. 20 compares the results of different algorithms. IDD exhibits significant noise and bias due to the ill-conditioned and linearized model, while InceptNet effectively reduces noise and improves accuracy, according to examples of the present disclosure. However, despite achieving comparable PSNR and SSIM to diffusion-based algorithms (CDDPM and Spectral DPS), InceptNet shows noticeable edge blurring, limiting soft tissue detail visualization. In contrast, diffusion-based algorithms can learn the underlying image distribution, and exhibited better resolution preservation. In the axial images, CDDPM and Spectral DPS show comparable performance on visual inspection and in quantitative metrics. However, Spectral DPS significantly outperforms CDDPM in mitigating cone-beam artifacts and adjacent slice discontinuities.

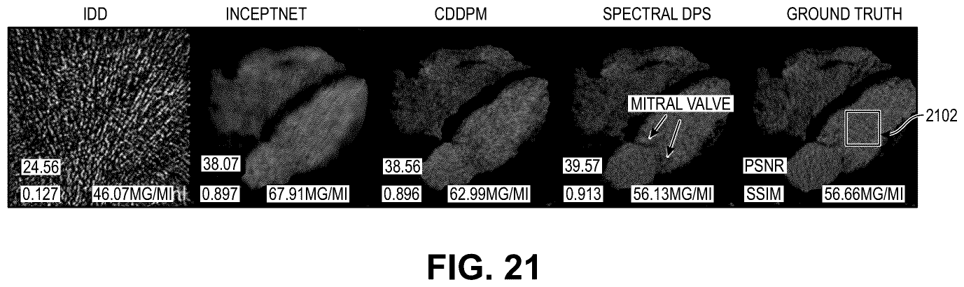

FIG. 21 shows cardiac ROI in calcium images according to examples of the present disclosure. The bright signal comes from the contrast enhancement, and the mean density (bottom right) within the box 2102 (20×20 pixels²) are computed to evaluate the contrast quantification accuracy. Contrast quantification, though not explicitly included in this study, can be inferred from the cardiovascular region visible as a low-density area in the calcium images. FIG. 21 displays zoomed-in images of the cardiac ROI. Spectral DPS achieved the best overall SSIM and PSNR. In the uniform box area, the mean density errors for InceptNet, CDDPM, and Spectral DPS are 19.86%, 11.17%, and 0.94% error, respectively. Spectral DPS provides the clearest depiction of the mitral valve, demonstrating its superior decomposition accuracy in contrast-enhanced regions.

### Computational Efficiency

Table VI compares the computational cost of different deep learning algorithms. InceptNet, with its end-to-end inference approach, demonstrates the lowest computational cost, requiring only 2.8 seconds and 5.6 GB of memory to process the 3D volume. Diffusion-based algorithms, which rely on iterative sampling, typically have the highest computational burden, e.g., CDDPM has a runtime of 7722 seconds and a memory requirement of 6.8 GB. The disclosed algorithm, while still involving computationally intensive projection, achieves a significant reduction in both runtime (2680 seconds) and memory usage (15.9 GB) compared to the 150-bin version (4020 seconds and 108.2 GB) by leveraging the compressed forward model. This demonstrates the improved efficiency and practical applicability.

| Method | Incept | CDDPM | Proposed(150 bin) | Proposed |
|---|---|---|---|---|
| Time(s) | 2.8 s | 7722 | 4020* | 2680 |
| Memory(GB) | 5.6 | 6.8 | 108.2* | 15.9 |

Computational cost of deep learning algorithms.

*The 150 bin values are estimated by linear extrapolation of a thin volume decomposition.

### Conclusion and Discussion

In this disclosure, the 2D Spectral DPS is extended to a 3D scenario. By leveraging a pre-trained 2D diffusion model and a compressed polychromatic forward model, Spectral DPS enables volumetric material decomposition on a single computer and GPU. Comparative studies demonstrate that Spectral DPS outperforms other deep learning algorithms in terms of accurate contrast quantification and inter-slice continuity, showcasing its capability for precise 3D material decomposition.

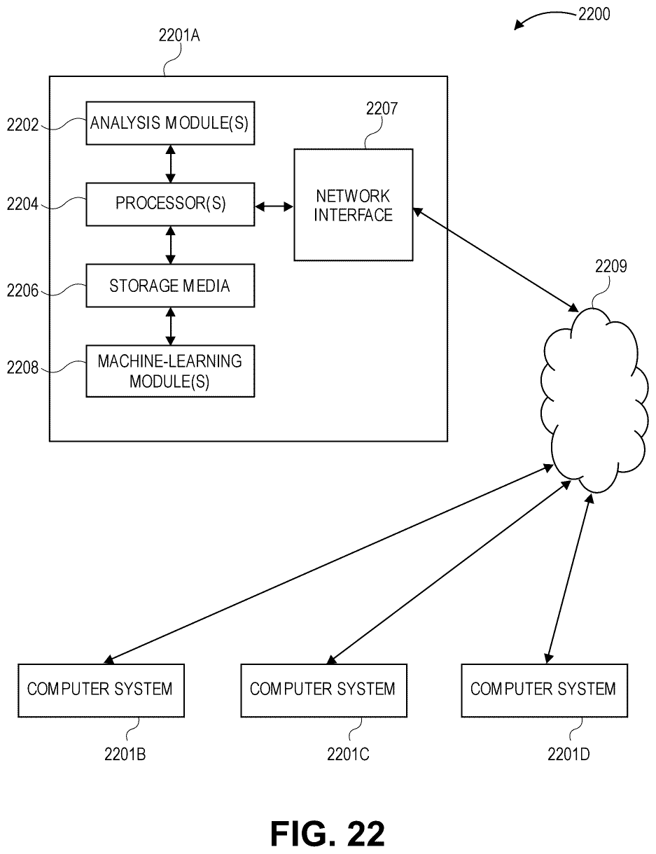

In some examples, any of the methods of the present disclosure may be executed by a computing system. FIG. 22 illustrates an example of such a computing system 2200, in accordance with some examples. The computing system 2200 may include a computer or computer system 2201A, which may be an individual computer system 2201A or an arrangement of distributed computer systems. The computer system 2201A includes one or more analysis module(s) 2202 configured to perform various tasks according to some embodiments, such as one or more methods disclosed herein. To perform these various tasks, the analysis module 2202 executes independently, or in coordination with, one or more processors 2204, which is (or are) connected to one or more storage media 2206. The processor(s) 2204 is (or are) also connected to a network interface 2207 to allow the computer system 2201A to communicate over a data network 2209 with one or more additional computer systems and/or computing systems, such as 2201B, 2201C, and/or 2201D (note that computer systems 2201B, 2201C and/or 2201D may or may not share the same architecture as computer system 2201A, and may be located in different physical locations, e.g., computer systems 2201A and 2201B may be located in a processing facility, while in communication with one or more computer systems such as 2201C and/or 2201D that are located in one or more data centers, and/or located in varying countries on different continents). A processor can include a microprocessor, microcontroller, processor module or subsystem, programmable integrated circuit, programmable gate array, or another control or computing device.

The storage media 2206 can be implemented as one or more computer-readable or machine-readable storage media. The storage media 2206 can be connected to or coupled with an image reconstruction machine learning module(s) 2208, including one or more deep learning neural networks. Note that while in the example embodiment of FIG. 22 storage media 2206 is depicted as within computer system 2201A, in some embodiments, storage media 2206 may be distributed within and/or across multiple internal and/or external enclosures of computing system 2201A and/or additional computing systems. Storage media 4706 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLURAY disks, or other types of optical storage, or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions or located at a remote site from which machine-readable instructions can be downloaded over a network for execution.

It should be appreciated that computing system 2200 is only one example of a computing system, and that computing system 2200 may have more or fewer components than shown, may combine additional components not depicted in the example embodiment of FIG. 22, and/or computing system 2200 may have a different configuration or arrangement of the components depicted in FIG. 22. The various components shown in FIG. 22 may be implemented in hardware, software, or a combination of both hardware and software, including one or more signal processing and/or application specific integrated circuits.

Further, the steps in the processing methods described herein may be implemented by running one or more functional modules in an information processing apparatus such as general purpose processors or application specific chips, such as ASICs, FPGAs, PLDs, or other appropriate devices. These modules, combinations of these modules, and/or their combination with general hardware are all included within the scope of protection of the invention.

The various above-described factors, models and/or other interpretation aids may be refined in an iterative fashion; this concept is applicable to embodiments of the present methods discussed herein. This can include use of feedback loops executed on an algorithmic basis, such as at a computing device (e.g., computing system 2200, FIG. 22), and/or through manual control by a user who may make determinations regarding whether a given step, action, template, model, or set of curves has become sufficiently accurate for the evaluation of the signal(s) under consideration.

Different examples of the apparatus(es) and method(s) disclosed herein include a variety of components, features, and functionalities. It should be understood that the various examples of the apparatus(es) and method(s) disclosed herein may include any of the components, features, and functionalities of any of the other examples of the apparatus(es) and method(s) disclosed herein in any combination, and all of such possibilities are intended to be within the scope of the present disclosure. Many modifications of examples set forth herein will come to mind to one skilled in the art to which the present disclosure pertains having the benefit of the teachings presented in the foregoing descriptions and the associated drawings.

Reference herein to “one example” means that one or more feature, structure, or characteristic described in connection with the example is included in at least one implementation. The phrase “one example” in various places in the specification may or may not be referring to the same example. As used herein, a system, apparatus, structure, article, element, component, or hardware “configured to” perform a specified function is indeed capable of performing the specified function without any alteration, rather than merely having potential to perform the specified function after further modification. In other words, the system, apparatus, structure, article, element, component, or hardware “configured to” perform a specified function is specifically selected, created, implemented, utilized, programmed, and/or designed for the purpose of performing the specified function. As used herein, “configured to” denotes existing characteristics of a system, apparatus, structure, article, element, component, or hardware which enable the system, apparatus, structure, article, element, component, or hardware to perform the specified function without further modification. For purposes of this disclosure, a system, apparatus, structure, article, element, component, or hardware described as being “configured to” perform a particular function may additionally or alternatively be described as being “adapted to” and/or as being “operative to” perform that function.

Notwithstanding that the numerical ranges and parameters setting forth the broad scope of the embodiments are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all sub-ranges subsumed therein. For example, a range of “less than 10” can include any and all sub-ranges between (and including) the minimum value of zero and the maximum value of 10, that is, any and all sub-ranges having a minimum value of equal to or greater than zero and a maximum value of equal to or less than 10, e.g., 1 to 5. In certain cases, the numerical values as stated for the parameter can take on negative values. In this case, the example value of range stated as “less than 10” can assume negative values, e.g. −1, −2, −3, −10, −20, −30, etc.

Furthermore, to the extent that the terms “including”, “includes”, “having”, “has”, “with”, or variants thereof are used in either the detailed description and the claims, such terms are intended to be inclusive in a manner similar to the term “comprising.” As used herein, the phrase “one or more of”, for example, A, B, and C means any of the following: either A, B, or C alone; or combinations of two, such as A and B, B and C, and A and C; or combinations of A, B and C.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. Moreover, the order in which the elements of the methods are illustrated and described may be re-arranged, and/or two or more elements may occur simultaneously. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A method for computed tomography (CT) reconstruction, the method comprising:
obtaining two or more spectral CT measurement data of different materials of a target from one or more 2D or 3D spectral CT images acquired by a CT imaging system using more than one CT imaging energy regimes; and
producing a pair reconstructed spectral CT images that are representative of densities of the different materials of the target by performing one or more iterations on the two or more spectral CT measurement data using a trained machine learning network that is trained to performing a diffusion sampling operation and a forward-model-based likelihood on one or more intermediate data sets representing the two or more spectral CT measurement data.

2. The method of claim 1, further comprising:
performing a filtered backprojection process on the pair of spectral CT measurement data to produce a pair of filtered backprojected spectral data;
performing an image-domain decomposition process on the pair of filtered backprojected spectral data to produce a pair of image-domain decomposed spectral data; and
adding noise to the pair of image-domain decomposed spectral data to produce a pair of noisy image-domain decomposed spectral data.

3. The method of claim 1, wherein the forward-model-based likelihood is a model that represents a system physical model.

4. The method of claim 1, wherein the trained machine learning network applies an estimated probability based on prior conditions to a prior score function estimator with a measurement likelihood score function from the forward-model-based likelihood that is derived from a nonlinear physical model to yield a posterior score function that is used to sample a reverse-time diffusion process.

5. The method of claim 4, wherein the trained machine learning network applies the estimated probability with a gradient of a log-likelihood from the nonlinear physical model to achieve the posterior score function for diffusion posterior sampling.

6. The method of claim 2, wherein the trained machine learning network starts at an intermediate state value that is between an initial state value and a final state value to reduce an CT image reconstruction time and a sampling variability, wherein the intermediate state value is approximated using a noisy image estimate, and wherein an initial spectral image comprises an expected level of noise for a starting time step.

7. The method of claim 1, wherein the likelihood-based forward model comprises a posterior-mean Jacobian term based on a gradient of an attenuation map to be reconstructed and a likelihood gradient term based on a measurement value, a first numeric representation that comprises information representative of system geometry of the CT imaging system, and a second numeric representation that comprises information representative of a pixel-dependent photon fluence, one or more gain factors, and a system induced blur.

8. The method of claim 1, further comprising training a untrained machine learning network by successively adding noise to images acquired by the CT imaging system to yield images representative of pure noise.

9. The method of claim 8, wherein the untrained machine learning network is trained on multi-material images, wherein the multi-material images comprise bone and water or bone, water, and iodine.

10. The method of claim 9, wherein the untrained machine learning network is trained on additional information that incorporates system unknowns, wherein the system unknowns comprise spectral sensitivity, gain factors. or physical effects, wherein the physical effects comprise scattered radiation.

11. The method of claim 1, wherein the trained machine learning network is configured to process images produced by CT imaging systems with different system geometries and different operating parameters than the CT imaging system that is used to train the trained machine learning network.

12. The method of claim 1, wherein one or more discontinuities between adjacent slices of the spectral data are corrected by a total variation regularization process along a vertical or z-direction.

13. A computer system comprising:
a processor; and
a computer-readable medium storing instructions to perform a method for computed tomography (CT) reconstruction, the method comprising:
obtaining two or more spectral CT measurement data of different materials of a target from one or more 2D or 3D spectral CT images acquired by a CT imaging system using more than one CT imaging energy regimes; and
producing a pair reconstructed spectral CT images that are representative of densities of the different materials of the target by performing one or more iterations on the two or more spectral CT measurement data using a trained machine learning network that is trained to performing a diffusion sampling operation and a forward-model-likelihood on one or more intermediate data sets representing the two or more spectral CT measurement data.

14. The computer system of claim 13, wherein the method further comprises:
performing a filtered backprojection process on the pair of spectral CT measurement data to produce a pair of filtered backprojected spectral data;
performing an image-domain decomposition process on the pair of filtered backprojected spectral data to produce a pair of image-domain decomposed spectral data; and
adding noise to the pair of image-domain decomposed spectral data to produce a pair of noisy image-domain decomposed spectral data.

15. The computer system of claim 13, wherein the forward-model-based likelihood is a model that represents a system physical model.

16. The computer system of claim 13, wherein the trained machine learning network applies an estimated probability based on prior conditions to a prior score function estimator with a measurement likelihood score function from the forward-model-based likelihood that is derived from a nonlinear physical model to yield a posterior score function that is used to sample a reverse-time diffusion process.

17. The computer system of claim 16, wherein the trained machine learning network applies the estimated probability with a gradient of a log-likelihood from the nonlinear physical model to achieve the posterior score function for diffusion posterior sampling.

18. The computer system of claim 14, wherein the trained machine learning network starts at an intermediate state value that is between an initial state value and a final state value to reduce an CT image reconstruction time and a sampling variability, wherein the intermediate state value is approximated using a noisy image estimate, and wherein an initial spectral image comprises an expected level of noise for a starting time step.

19. The computer system of claim 13, wherein the likelihood-based forward model comprises a posterior-mean Jacobian term based on a gradient of an attenuation map to be reconstructed and a likelihood gradient term based on a measurement value, a first numeric representation that comprises information representative of system geometry of the CT imaging system, and a second numeric representation that comprises information representative of a pixel-dependent photon fluence, one or more gain factors, and a system induced blur.

20. A method for computed tomography (CT) reconstruction, the method comprising:
obtaining a single set of projection data of a target from one or more 2D or 3D CT images acquired by a CT imaging system using a single CT imaging energy regime; and
producing a signal volume of attenuation coefficients that are representative of the target by performing one or more iterations on the two or more CT measurement data using a trained machine learning network that is trained to performing a diffusion sampling operation and a forward-model-based likelihood on one or more intermediate data sets representing the two or more CT measurement data.
